(19) United States
(12) Patent Application Publication
(10) Pub. No.: US 2025/0358224 A1
(43) Pub. Date: Nov. 20, 2025

(54) COMMUNICATION DEVICE, NETWORK SYSTEM, COMMUNICATION METHOD, AND RECORDING MEDIUM

(71) Applicant: Mitsubishi Electric Corporation, Tokyo (JP)

(72) Inventor: Masanori IMAIZUMI, Tokyo (JP)

(21) Appl. No.: 18/874,644

(22) PCT Filed: Dec. 19, 2023
(86) PCT No.: PCT/JP2023/045403

§ 371 Date: Dec. 13, 2024

(30) Foreign Application Priority Data
Jan. 17, 2023 (WO) PCT/JP2023/001219
Jun. 8, 2023 (WO) PCT/JP2023/021348

(51) Int. Cl. H04L 45/74; H04L 12/66; H04L 45/745; H04L 61/5007

(52) U.S. Cl. CPC H04L 45/742; H04L 45/745; H04L 12/66; H04L 61/5007

(57) ABSTRACT

A storage stores a routing table with which a record is registered. The record includes a destination network ID, a subnet mask, and a gateway IP address. A table manager registers a first record with the routing table and updates the routing table to indicate, as a default route, a second path through a second communication network. The first record includes, as the destination network ID, an IP address of a first communication device connected to a communication device through a first communication network, includes a full-bit subnet mask as the subnet mask, and includes, as the gateway IP address, an IP address of a first gateway connected to the first communication network or identification information of a first communication adapter. This structure can appropriately determine a communication path with a simple structure without user effort.

### CROSS REFERENCE TO RELATED APPLICATION

This application is a U.S. national stage application of PCT/JP2023/045403 filed on Dec. 19, 2023, which is based on and claims the benefit of priority of the prior International Patent Application No. PCT/JP2023/021348 filed on Jun. 8, 2023, and the prior International Patent Application No. PCT/JP2023/001219 filed on Jan. 17, 2023, both the contents of which are incorporated herein by reference.

### TECHNICAL FIELD

The present disclosure relates to a communication device, a network system, a communication method, and a program.

### BACKGROUND

A known communication device is connectable to multiple communication networks such as a mobile phone network and a wireless local area network (LAN). Such a communication device includes multiple communication adapters connectable to the corresponding communication networks. The communication device basically uses a routing table to identify a communication adapter corresponding to the subnet to which a communication target device belongs, and communicates with the communication target device using the identified communication adapter.

When the subnet to which the communication target device belongs is not registered with the routing table, the communication uses a communication adapter connectable to a default gateway. However, with the communication adapter connectable to the default gateway, the communication device may not connect to the subnet to which the communication target device belongs. Various techniques to respond to this issue are currently being developed. For example, Patent Literature 1 describes a technique for determining a communication path using a dummy address and determining a communication adapter used for communication.

### PATENT LITERATURE

Patent Literature 1: Unexamined Japanese Patent Application Publication No. 2006-333808

The technique described in Patent Literature 1 diverges greatly from the implementation of Transmission Control Protocol/Internet Protocol (TCP/IP) and involves complicated processing. The subnet to which a communication target device belongs may be registered with the routing table within the scope of TCP/IP implementation. However, this method causes the user to identify the subnet to which the communication target device belongs, increasing user effort. A technique is thus awaited for appropriately determining a communication path with a simple structure without user effort.

### SUMMARY

In response to the above issue, one or more aspects of the present disclosure are directed to a communication device, a network system, a communication method, and a program that appropriately determine a communication path with a simple structure without user effort.

To achieve the above objective, a communication device according to an aspect of the present disclosure is a communication device connectable to a first communication network and a second communication network. The communication device includes a first communication adapter connectable to the first communication network, a second communication adapter connectable to the second communication network, storage means, and table management means. The storage means stores a routing table with which a record is registered. The record includes a destination network ID, a subnet mask, and a gateway IP address, where ID is identification, and IP is Internet Protocol. The table management means registers a first record with the routing table and updates the routing table to indicate a second path as a default route selectively from a first path through the first communication network and the second path through the second communication network. The first record includes, as the destination network ID, an IP address of a first communication device connected to the communication device through the first communication network, includes a full-bit subnet mask as the subnet mask, and includes, as the gateway IP address, an IP address of a first gateway connected to the first communication network or identification information of the first communication adapter.

In the communication device according to the above aspect of the present disclosure, the first record is registered with the routing table. The first record includes the IP address of the first communication device as the destination network ID, the full-bit subnet mask as the subnet mask, and the IP address of the first gateway or the identification information of the first communication adapter as the gateway IP address. The routing table is updated to indicate, as the default route, the second path through the second communication network. The communication device according to the above aspect of the present disclosure can thus appropriately determine a communication path with a simple structure without user effort.

### BRIEF DESCRIPTION OF DRAWINGS

FIG. 1 is a block diagram of a network system according to Embodiment 1;

FIG. 2 is a block diagram of a communication device according to Embodiment 1;

FIG. 3 is a functional block diagram of the communication device according to Embodiment 1;

FIG. 4A is a routing table before addition of a communication target in Embodiment 1,

FIG. 4B is a routing table after addition of a communication target in Embodiment 1, and FIG. 4C is a routing table after deletion of a default gateway in Embodiment 1;

FIG. 5 is a flowchart of a table management process performed by the communication device according to Embodiment 1;

FIG. 6 is a flowchart of a record registration process in FIG. 5;

FIG. 7 is a block diagram of a network system according to Embodiment 2;

FIG. 8 is a functional block diagram of a communication device according to Embodiment 2;

FIG. 9 is a diagram of a communication target information registration screen;

FIG. 10A is a routing table after addition of a domain name system (DNS) server in Embodiment 2, FIG. 10B is a routing table after addition of a communication target in Embodiment 2, and FIG. 10C is a routing table after deletion of a default gateway in Embodiment 2;

FIG. 11 is a flowchart of a table management process performed by the communication device according to Embodiment 2;

FIG. 12 is a block diagram of a network system according to Embodiment 3;

FIG. 13A is a routing table before addition of a communication target in Embodiment 3, FIG. 13B is a routing table after addition of a communication target in Embodiment 3, and FIG. 13C is a routing table after deletion of a default gateway in Embodiment 3;

FIG. 14 is a block diagram describing a procedure for updating the network setting of a communication device according to Embodiment 4;

FIG. 15 is a flowchart of a setting correction process performed by the communication device according to Embodiment 4;

FIG. 16 is a block diagram of a network system according to Embodiment 5;

FIG. 17 is a functional block diagram of a communication device according to Embodiment 5;

FIG. 18 is a block diagram describing a name resolution method implemented by the communication device according to Embodiment 5;

FIG. 19A is a routing table after addition of a DNS server in Embodiment 5, FIG. 19B is a routing table after addition of a communication target in Embodiment 5, and FIG. 19C is a routing table after deletion of a default gateway in Embodiment 5;

FIG. 20A is a routing table after addition of a DNS server in Embodiment 6, FIG. 20B is a routing table after addition of a communication target in Embodiment 6, and FIG. 20C is a routing table after deletion of a default gateway in Embodiment 6;

FIG. 21 is a block diagram of a network system according to Embodiment 7;

FIG. 22A is a routing table after addition of a DNS server in Embodiment 7, FIG. 22B is a routing table after addition of a communication target in Embodiment 7, and FIG. 22C is a routing table after deletion of a default gateway in Embodiment 7; and

FIG. 23A is a routing table after addition of a DNS server in Embodiment 8, FIG. 23B is a routing table after addition of a communication target in Embodiment 8, and FIG. 23C is a routing table after deletion of a default gateway in Embodiment 8.

### DETAILED DESCRIPTION

Embodiments of the present disclosure are described in detail below with reference to the drawings. Like reference signs denote like or corresponding components in the drawings.

### Embodiment 1

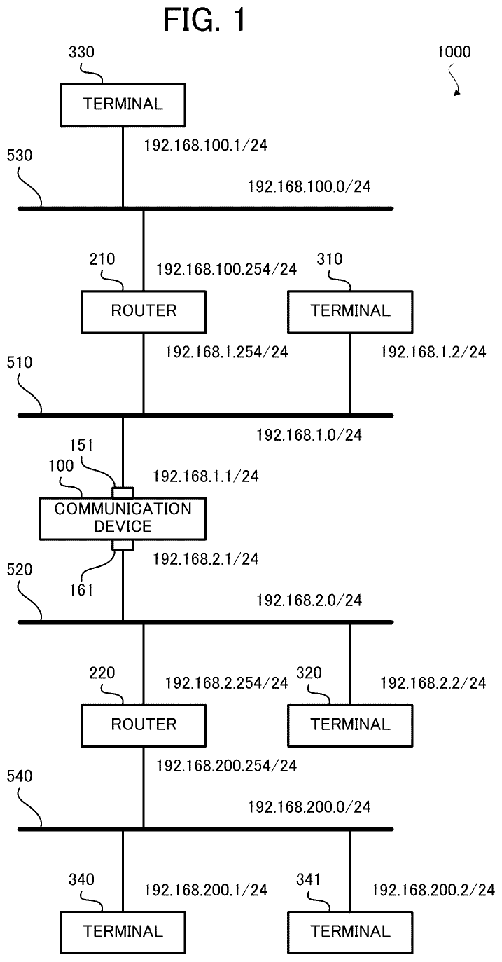

FIG. 1 is a block diagram of a network system 1000 according to the present embodiment. The network system 1000 includes a communication device 100, a router 210, a router 220, a terminal 310, a terminal 320, a terminal 330, a terminal 340, a terminal 341, a communication network 510, a communication network 520, a communication network 530, and a communication network 540.

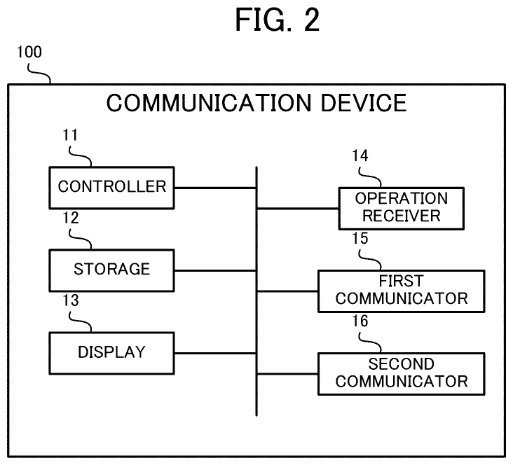

The communication device 100 communicates with other devices using a communication adapter 151 and a communication adapter 161. The other devices are hereafter referred to as communication target devices as appropriate. The communication device 100 refers to a routing table (described later) and selects a communication adapter used for communication. The communication device 100 manages, for example, a facility. As illustrated in FIG. 2, the communication device 100 includes a controller 11, a storage 12, a display 13, an operation receiver 14, a first communicator 15, and a second communicator 16.

The controller 11 includes, for example, a central processing unit (CPU), a read-only memory (ROM), a random-access memory (RAM), and a real-time clock (RTC). The CPU may also be referred to as, for example, a central processing device, a central arithmetic device, a processor, a microprocessor, a microcomputer, or a digital signal processor (DSP), and functions as a central arithmetic processing unit that performs processes and arithmetic operations for controlling the communication device 100. In the controller 11, the CPU reads programs and data stored in the ROM and centrally controls the communication device 100 using the RAM as a work area. The RTC is, for example, an integrated circuit as a timekeeper. The CPU can identify the current date and time using time information read from the RTC.

The storage 12 includes a nonvolatile semiconductor memory, such as a flash memory, an erasable programmable ROM (EPROM), or an electrically erasable programmable ROM (EEPROM), and serves as an auxiliary storage device. The storage 12 stores programs and data to be used by the controller 11 to perform various processes. The storage 12 also stores data generated or acquired by the controller 11 through various processes. The storage 12 stores the routing table (described later).

The display 13 displays various images under control of the controller 11. For example, the display 13 displays a screen for receiving various operations from a user. The display 13 includes, for example, a touchscreen or a liquid crystal display. The operation receiver 14 receives various operations from the user and provides the controller 11 with information indicating the received operations. The operation receiver 14 includes, for example, a touchscreen, a button, or a lever.

The first communicator 15 communicates with devices connected to the communication network 510 under control of the controller 11. The first communicator 15 is connectable to the communication network 510 and communicates with, for example, the router 210 and the terminal 310 connected to the communication network 510. The first communicator 15 includes the communication adapter 151 for connecting to the communication network 510 based on the Transmission Control Protocol/Internet Protocol (TCP/IP) standard. The communication adapter 151 is a communication interface complying with a standard such as Wi-Fi (registered trademark) or Ethernet (registered trademark).

The second communicator 16 communicates with devices connected to the communication network 520 under control of the controller 11. The second communicator 16 is connectable to the communication network 520 and communicates with, for example, the router 220 and the terminal 320 connected to the communication network 520. The second communicator 16 includes the communication adapter 161 for connecting to the communication network 520 based on the TCP/IP standard. The communication adapter 161 is a communication interface complying with a standard such as Wi-Fi (registered trademark) and Ethernet (registered trademark).

The router 210 is a communication device for connecting the communication network 510 and the communication network 530. The router 210 relays data between the communication network 510 and the communication network 530. The router 210 includes a communication adapter (not illustrated) for connecting to the communication network 510 and a communication adapter (not illustrated) for connecting to the communication network 530. The router 210 functions as a gateway.

The router 220 is a communication device for connecting the communication network 520 and the communication network 540. The router 220 relays data between the communication network 520 and the communication network 540. The router 220 includes a communication adapter (not illustrated) for connecting to the communication network 520 and a communication adapter (not illustrated) for connecting to the communication network 540. The router 220 functions as a gateway.

The terminal 310 is connected to the communication network 510. The terminal 310 includes a communication adapter (not illustrated) for connecting to the communication network 510. The terminal 320 is connected to the communication network 520. The terminal 320 includes a communication adapter (not illustrated) for connecting to the communication network 520.

The terminal 330 is connected to the communication network 530. The terminal 330 includes a communication adapter (not illustrated) for connecting to the communication network 530. The terminal 340 and the terminal 341 are connected to the communication network 540. Each of the terminal 340 and the terminal 341 includes a communication adapter (not illustrated) for connecting to the communication network 540.

The communication network 510, the communication network 520, the communication network 530, and the communication network 540 are different from one another. Each of the communication network 510, the communication network 520, the communication network 530, and the communication network 540 is, for example, a wireless local area network (LAN) or a wired LAN at the facility. The communication network 510, the communication network 520, the communication network 530, and the communication network 540 transmit and receive data based on the TCP/IP standard.

A method implemented by the communication device 100 for identifying a communication path using the routing table is now described. The routing table lists the paths to individual network destinations. In the present embodiment, the routing table includes records each including a destination network identification (ID), a subnet mask, a gateway IP address, and a communication adapter IP address.

The destination network ID is the ID of a destination communication network. The destination network ID is represented in the same format as an IP address. In Internet Protocol version (IPv) 4, an IP address may be represented by combining four numbers in decimal notation ranging from 0 to 255, or may be represented by a 32-bit binary number separated for every 8 bits. The network ID is hereafter referred to as a subnet as appropriate.

The subnet mask is a numerical value for identifying a network address portion and a host address portion in an IP address and extracting the network address portion from the IP address. The network address portion in the IP address indicates a network. The host address portion in the IP address indicates a terminal. The subnet mask is represented by, for example, a decimal number, a hexadecimal number, or a binary number.

The gateway IP address is the IP address of a gateway used for connection to the destination communication network. The gateway IP address is the IP address in the connection source communication network with respect to the gateway. The communication adapter IP address is the IP address of a communication adapter used for connection to the destination communication network.

In the example described below, the IP address of the communication device 100 in the communication network 510 (hereafter simply referred to as the IP address of the communication device 100 as appropriate) is divided into a network address portion and a host address portion using a subnet mask.

In the present embodiment, the IP address of the communication device 100 is 192.168.1.1 in decimal notation and 11000000.10101000.00000001.00000001 in binary notation. In this example, the subnet mask is 255.255.255.0 in decimal notation and 11111111.11111111.11111111.00000000 in binary notation.

The logical AND of the IP address of the communication device 100 in binary notation and the subnet mask in binary notation is 11000000.10101000.00000001.00000000 in binary notation and 192.168.1.0 in decimal notation. This numerical value 192.168.1.0 is the network ID of the communication network 510 to which the communication device 100 belongs. In such a subnet mask in binary notation, the portion corresponding to 1 is the network address portion, and the portion corresponding to 0 is the host address portion.

The number of 1s in a subnet mask in binary notation is referred to as a subnet mask length. For example, a subnet mask of 255.255.255.0 in decimal notation has a subnet mask length of 24. To represent the subnet mask length in an IP address or a network ID in IPV4, the subnet mask length may be added at the end of the IP address or the network ID. For example, the IP address of the communication device 100 may be written as 192.168.1.1/24, and the network ID of the communication network 510 may be written as 192.168.1.0/24.

In the present embodiment, the IP address of the communication device 100 in the communication network 510, or more specifically, the IP address assigned to the communication adapter 151 is 192.168.1.1/24. The IP address of the communication device 100 in the communication network 520, or more specifically, the IP address assigned to the communication adapter 161 is 192.168.2.1/24. The IP address of the router 210 in the communication network 510 is 192.168.1.254/24.

The IP address of the router 210 in the communication network 530 is 192.168.100.254/24. The IP address of the router 220 in the communication network 520 is 192.168.2.254/24. The IP address of the router 220 in the communication network 540 is 192.168.200.254/24.

The IP address of the terminal 310 is 192.168.1.2/24. The IP address of the terminal 320 is 192.168.2.2/24. The IP address of the terminal 330 is 192.168.100.1/24. The IP address of the terminal 340 is 192.168.200.1/24. The IP address of the terminal 341 is 192.168.200.2/24.

The network ID of the communication network 510 is 192.168.1.0/24. The network ID of the communication network 520 is 192.168.2.0/24. The network ID of the communication network 530 is 192.168.100.0/24. The network ID of the communication network 540 is 192.168.200.0/24.

The IP address of each device is assigned by, for example, a dynamic host configuration protocol (DHCP) server connected to the corresponding communication network. For example, the IP address of the communication device 100 in the communication network 510 is assigned by the DHCP server (not illustrated) connected to the communication network 510. The IP address of the communication device 100 in the communication network 520 is assigned by the DHCP server (not illustrated) connected to the communication network 520.

The DHCP server connected to the corresponding communication network provides each device with the IP address of a default gateway. For example, the DHCP server (not illustrated) connected to the communication network 510 provides the communication device 100 with the IP address of the router 210 that is set as a default gateway. For example, the DHCP server (not illustrated) connected to the communication network 520 provides the communication device 100 with the IP address of the router 220 that is set as a default gateway.

In this case, the communication device 100 registers both the router 210 and the router 220 with the routing table as default gateways. In the present embodiment, registering a default gateway refers to registering a record corresponding to the default gateway. A default gateway is used for communicating with a communication target for which no specific path is registered with the routing table. Specifying a default gateway corresponds to specifying a default route, and also corresponds to specifying a communication adapter connectable to the default gateway. A default route is a path used for communicating with a communication target for which no specific path is registered with the routing table.

A record (hereafter referred to as a record A as appropriate) for setting the router 210 as a default gateway includes the destination network ID of 0.0.0.0, the subnet mask of 0.0.0.0, the gateway IP address of 192.168.1.254, and the communication adapter IP address of 192.168.1.1. For example, a record (hereafter referred to as a record B as appropriate) for setting the router 220 as a default gateway includes the destination network ID of 0.0.0.0, the subnet mask of 0.0.0.0, the gateway IP address of 192.168.2.254, and the communication adapter IP address of 192.168.2.1.

When the communication device 100 and a communication target device are connected to the same communication network, the communication device 100 can communicate with the communication target device based on the TCP/IP standard without referring to the routing table. For example, with the communication device 100 and the terminal 310 both connected to the communication network 510, the communication device 100 can communicate with the terminal 310 through the communication adapter 151 connectable to the communication network 510. For example, with the communication device 100 and the terminal 320 both connected to the communication network 520, the communication device 100 can communicate with the terminal 320 through the communication adapter 161 connectable to the communication network 520.

When the communication device 100 and a communication target device are not connected to the same communication network, the communication device 100 refers to the routing table and determines the path to the communication target device based on the TCP/IP standard. When the communication device 100 transmits a packet to the communication target device through an appropriate communication adapter, the packet is received by the router 210 or the router 220 that then transmits the packet appropriately to the communication target device. Thus, the communication device 100 may appropriately determine the communication adapter used for communication with the communication target device. In other words, determining the path to a communication target device basically refers to determining the communication adapter used for communication with the communication target device in the present embodiment.

When the communication device 100 and a communication target device are not connected to the same communication network, the communication device 100 communicates with the communication target device using the communication adapter having the communication adapter IP address included in the record with the greatest subnet mask length, selectively from the records corresponding to the communication network to which the communication target device is connected. The records corresponding to the communication network to which the communication target device is connected each refer to a record in which the destination network ID matches the logical AND of the IP address of the communication target device and the subnet mask in the record.

For example, the communication device 100 communicates with the terminal 330, with a record (hereafter referred to as a record C as appropriate) registered with the routing table including the destination network ID of 192.168.100.0, the subnet mask of 255.255.255.0, the gateway IP address of 192.168.1.254, and the communication adapter IP address of 192.168.1.1. In this case, the logical AND of the IP address of the terminal 330, 192.168.100.1, and the subnet mask in the record C, 255.255.255.0, is 192.168.100.0 that matches the destination network ID in the record C, 192.168.100.0. The record C is thus a record corresponding to the communication network to which the communication target device is connected.

The record A and the record B corresponding to the default gateways are also registered with the routing table. The logical AND of the IP address of the terminal 330, 192.168.100.1, and the subnet mask in the record A, 0.0.0.0, is 0.0.0.0 that matches the destination network ID in the record A, 0.0.0.0. Similarly, the logical AND of the IP address of the terminal 330, 192.168.100.1, and the subnet mask in the record B, 0.0.0.0, is 0.0.0.0 that matches the destination network ID in the record B, 0.0.0.0. The record A and the record B are thus records corresponding to the communication network to which the communication target device is connected.

In this example, the subnet mask length in the record A is 0, the subnet mask length in the record B is 0, and the subnet mask length in the record Cis 24. The communication device 100 thus determines, as a communication adapter used for communication with the terminal 330, the communication adapter 151 with 192.168.1.1 that is the communication adapter IP address included in the record C.

However, the user may often have difficulty in identifying the network ID of the communication network to which a communication target device is connected and registering, with the routing table, the record corresponding to the communication network to which the communication target device is connected. For example, the user may often have difficulty in identifying the network ID of the communication network 530 to which the terminal 330 is connected. In this case, the user has difficulty in registering the record C with the routing table. In this case, the communication device 100 identifies the record A and the record B as the records corresponding to the communication network to which the communication target device is connected.

However, the subnet mask length in the record A is 0, and the subnet mask length in the record B is 0. The communication device 100 thus cannot easily determine the record to use, or specifically, the record A or the record B. In other words, the communication device 100 cannot easily determine the communication adapter to use for communication with the terminal 330, or specifically, the communication adapter 151 or the communication adapter 161. When the communication device 100 uses the communication adapter 161 as a communication adapter for communicating with the terminal 330, the communication device 100 cannot communicate with the terminal 330.

In the present embodiment, the communication device 100 generates a record used for communication with a communication target device using communication target information that can be easily identified by the user, and registers the generated record with the routing table. In the present embodiment, the communication target information includes the IP address of the communication target device and identification information of a communication adapter used for communication with the communication target device. In other words, although the user is not familiar with the network structure, the user can easily identify the IP address of the communication target device and the identification information of the communication adapter used for communication with the communication target device.

The communication device 100 identifies, using the identification information of the communication adapter used for communication with the communication target device, the IP address of the gateway used for communication with the communication target device and the IP address of the communication adapter used for communication with the communication target device. The communication device 100 generates a record in which the destination network ID is the IP address of the communication target device, the subnet mask is a full-bit subnet mask, 255.255.255.255, the gateway IP address is the IP address of the gateway used for communication with the communication target device, and the communication adapter IP address is the IP address of the communication adapter used for communication with the communication target device.

In the above example, for example, the communication device 100 acquires, from the user, communication target information including the IP address of the terminal 330 as a communication target device, 192.168.100.1, and the identification information of the communication adapter 151 used for communication with the terminal 330. The communication device 100 identifies the IP address of the communication adapter 151, 192.168.1.1, using the identification information of the communication adapter 151. The communication device 100 identifies the IP address of the gateway used for communication with the terminal 330, 192.168.1.254, using the IP address of the communication adapter 151.

The communication device 100 then generates a record (hereafter referred to as a record D as appropriate) including the destination network ID of 192.168.100.1, the subnet mask of 255.255.255.255, the gateway IP address of 192.168.1.254, and the communication adapter IP address of 192.168.1.1. The communication device 100 registers the record D with the routing table.

In this state, the record A, the record B, and the record D are registered with the routing table. When the communication device 100 communicates with the terminal 330, the communication device 100 identifies the record D having the greatest subnet mask length selectively from the record A, the record B, and the record D, and determines the communication adapter 151 indicated by the record D as the communication adapter used for communication with the terminal 330. The destination network ID in the record D is set to the IP address of the communication target device rather than the ID of the destination communication network. Thus, the routing table can be used within the scope of TCP/IP implementation, although the use of the routing table in the present embodiment is different from the common use of a routing table.

When the communication device 100 communicates with a communication target device that is not connected to the communication network 510 or the communication network 520, the communication device 100 may preregister a record corresponding to the communication target device and similar to the record D with the routing table. However, when the system includes a large number of unspecified communication target devices that are not connected to the communication network 510 or the communication network 520, the records corresponding to the large number of unspecified communication target devices cannot be easily registered with the routing table. Thus, for such a large number of unspecified communication target devices, the default gateway may be used for communication.

For example, a small number of communication target devices are connected to the communication network 530, and a large number of unspecified communication target devices are connected to the communication network 540. For the communication target devices connected to the communication network 530, the communication device 100 may register records corresponding to the communication target devices with the routing table, and use the gateways indicated by the records to communicate with the communication target devices.

For the communication target devices connected to the communication network 540, the communication device 100 may use a default gateway to communicate with the communication target devices. In this case, the record A is deleted from the routing table selectively from the record A indicating the router 210 as a default gateway and the record B indicating the router 220 as a default gateway. For example, the communication device 100 may use the router 220 indicated as a default gateway by the record B to communicate with the terminal 340 and the terminal 341.

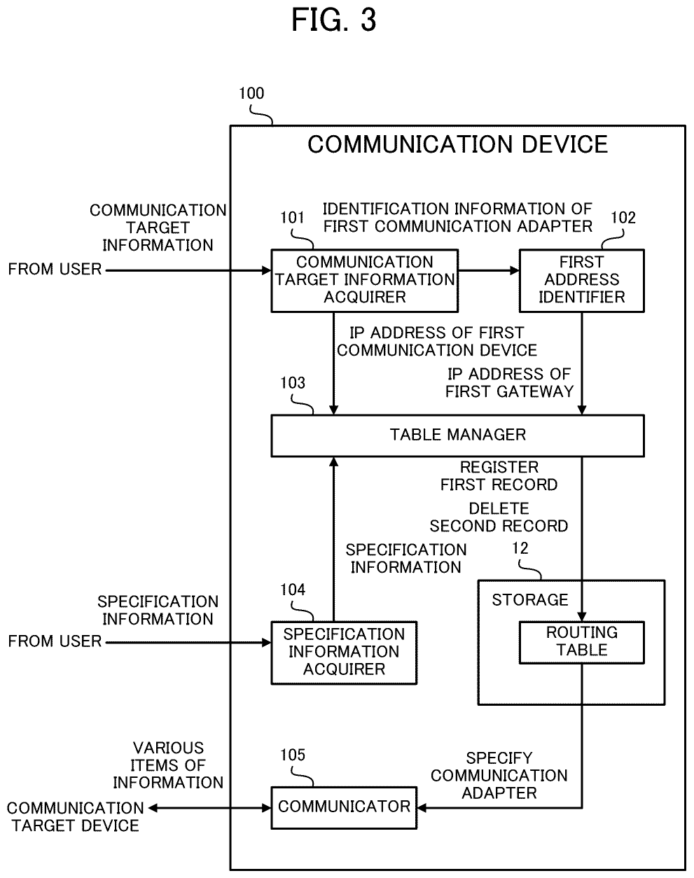

The functions of the communication device 100 are now described with reference to FIG. 3. The communication device 100 includes, as functional components, a communication target information acquirer 101, a first address identifier 102, a table manager 103, a specification information acquirer 104, and a communicator 105. These functions are implemented by software, firmware, or a combination of software and firmware. The software and the firmware are described as programs that are stored in the ROM or the storage 12. When the CPU executes the programs stored in the ROM or the storage 12, the above functions are implemented.

The communication device 100 is connected to a first communication network to which a first gateway is connected and to a second communication network to which a second gateway is connected. The router 210 is an example of the first gateway. The router 220 is an example of the second gateway. The communication network 510 is an example of the first communication network. The communication network 520 is an example of the second communication network.

The communication device 100 includes a first communication adapter connectable to the first communication network and a second communication adapter connectable to the second communication network. The communication adapter 151 is an example of the first communication adapter. The communication adapter 161 is an example of the second communication adapter. The storage 12 stores a routing table with which records each including a destination network ID, a subnet mask, and a gateway IP address are registered. The storage 12 is an example of storage means.

The communication target information acquirer 101 acquires communication target information from the user. The communication target information identifies the IP address of a first communication device and the IP address of the first gateway. In the present embodiment, the communication target information includes the IP address of the first communication device and the identification information of the first communication adapter. The first communication device is connected to the communication device 100 with the first gateway and is a communication target device for the communication device 100. The terminal 330 is an example of the first communication device. The communication target information acquirer 101 is an example of communication target information acquisition means.

The first address identifier 102 identifies the IP address of the first gateway using the identification information of the first communication adapter included in the communication target information. The identification information of the first communication adapter may be the IP address of the first communication adapter or the name of the first communication adapter. The first address identifier 102 can identify the IP address of the first communication adapter using the name of the first communication adapter based on, for example, correspondence information stored in the storage 12. The correspondence information includes the IP address of the first communication adapter and the name of the first communication adapter in a manner associated with each other.

The first address identifier 102 refers to, for example, the routing table and identifies the IP address of the first gateway corresponding to the IP address of the first communication adapter. For example, the first address identifier 102 identifies a record indicating a default gateway selectively from the records registered with the routing table. The record indicating the default gateway is a record in which each of the destination network ID and the subnet mask is 0.0.0.0.

The first address identifier 102 identifies a record in which the communication adapter IP address matches the IP address of the first communication adapter, selectively from the records indicating default gateways. The first address identifier 102 identifies the gateway IP address indicated by the identified record as the IP address of the first gateway. The first address identifier 102 is an example of first address identification means.

The table manager 103 registers a first record with the routing table. The first record includes the IP address of the first communication device as the destination network ID, a full-bit subnet mask as the subnet mask, and the IP address of the first gateway or the identification information of the first communication adapter as the gateway IP address. The first record is a record for identifying the gateway or the communication adapter used for communicating with the first communication device. In the present embodiment, the first communication network is a LAN, and the IP address of the first gateway connected to the first communication network can be identified. Thus, in the present embodiment, the first record includes the IP address of the first gateway as the gateway IP address. The record D described above is an example of the first record.

The table manager 103 sets, as the destination network ID included in the first record, the IP address of the first communication device included in the communication target information acquired by the communication target information acquirer 101. The table manager 103 sets, as the subnet mask included in the first record, a full-bit subnet mask. The table manager 103 sets, as the gateway IP address included in the first record, the IP address of the first gateway identified by the first address identifier 102.

The table manager 103 updates the routing table to indicate a second path as a default route selectively from a first path and the second path. The first path is a path through the first communication network. The second path is a path through the second communication network. More specifically, when a record corresponding to a communication target is not registered with the routing table, the table manager 103 updates the routing table to indicate communication to be performed through the second communication network. Communication through the second communication network corresponds to communication through the second gateway. In the present embodiment, the table manager 103 updates the routing table to indicate the second gateway as a default gateway.

For example, the table manager 103 registers the first record with the routing table, and deletes a second record from the routing table selectively from the second record and a third record. The second record indicates the first path as a default route. The third record indicates the second path as a default route. In the present embodiment, the default route is specified by specifying a default gateway. In other words, the second record indicates the first gateway as a default gateway. The third record indicates the second gateway connected to the second communication network as a default gateway.

The record A described above is an example of the second record. The record B described above is an example of the third record. Thus, the communication device 100 registers, with the routing table, a record corresponding to a communication target device that is not connected to the same communication network as the communication device 100 and with which the communication device 100 cannot communicate through the default gateway. In contrast, the communication device 100 does not register, with the routing table, a record corresponding to a communication target device connected to the same communication network as the communication device 100 or a record corresponding to a communication target device with which the communication device 100 can communicate through the default gateway. The table manager 103 is an example of table management means.

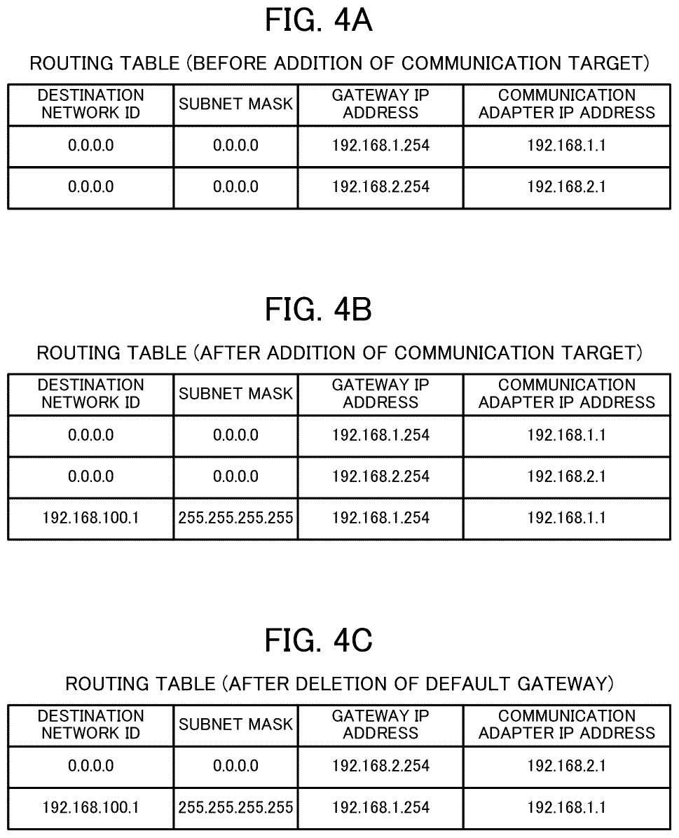

The details of the routing table updated by the table manager 103 are now described with reference to FIGS. 4A to 4C. FIG. 4A is the routing table before addition of a communication target. As illustrated in FIG. 4A, the routing table before addition of a communication target includes the second record indicating the first gateway as a default gateway and the third record indicating the second gateway as a default gateway. In FIG. 4A, the record in the first row is the second record, and the record in the second row is the third record. FIG. 4B is the routing table after addition of a communication target. As illustrated in FIG. 4B, the routing table after addition of a communication target includes the second record indicating the first gateway as a default gateway, the third record indicating the second gateway as a default gateway, and the first record indicating the gateway and the communication adapter for communicating with the first communication device. In FIG. 4B, the record in the first row is the second record, the record in the second row is the third record, and the record in the third row is the first record.

FIG. 4C is the routing table after deletion of a default gateway. As illustrated in FIG. 4C, the routing table after deletion of a default gateway includes the third record indicating the second gateway as a default gateway and the first record indicating the gateway and the communication adapter for communicating with the first communication device. In FIG. 4C, the record in the first row is the third record, and the record in the second row is the first record.

The communication device 100 can refer to the routing table after deletion of a default gateway to determine the communication adapter used for communication with the communication target device. For example, the communication device 100 can communicate with the terminal 330 as the first communication device through the router 210 indicated as a gateway by the first record. The communication device 100 can also communicate with the terminal 340 that is not the first communication device through the router 220 indicated as a default gateway by the third record. Similarly, the communication device 100 can communicate with the terminal 341 that is not the first communication device through the router 220 indicated as a default gateway by the third record.

The specification information acquirer 104 acquires specification information from the user. The specification information specifies a default gateway. In the present embodiment, the specification information includes, for example, the IP address of a gateway specified as a default gateway. A gateway basically corresponds to a communication adapter connectable to the gateway. The specification information may thus specify a communication adapter connectable to the default gateway. For example, the specification information may include the IP address of a communication adapter connectable to the default gateway. The table manager 103 deletes, from the routing table, a record corresponding to the gateway that is not specified as a default gateway by the specification information. In the present embodiment, the second gateway is specified as a default gateway by the specification information. Thus, the second record corresponding to the first gateway that is not specified as a default gateway by the specification information is deleted from the routing table.

The communicator 105 communicates with the first communication device through the first gateway indicated by the first record registered with the routing table. For a second communication device connected to the communication device 100 with the second gateway, the communicator 105 communicates with the second communication device through the second gateway that is a default gateway indicated by the routing table. Each of the terminal 340 and the terminal 341 is an example of the second communication device.

As described above, the communicator 105 communicates with a communication target device by referring to the routing table stored in the storage 12. More specifically, the communicator 105 determines, for each of all the records included in the routing table, whether the logical AND of the IP address of the communication target device and the subnet mask matches the destination network ID. The communicator 105 identifies a record having the greatest subnet mask length selectively from records in which the logical AND of the IP address of the communication target device and the subnet mask matches the destination network ID. The communicator 105 communicates with the communication target device through the gateway indicated by the identified record using the communication adapter indicated by the identified record.

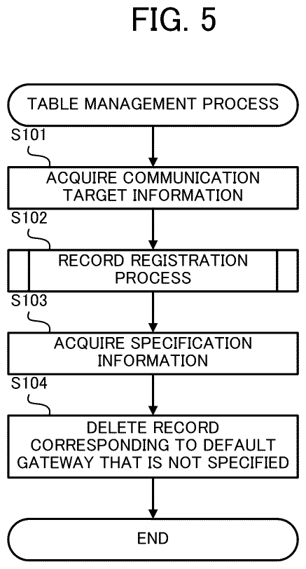

A table management process performed by the communication device 100 is now described with reference to the flowchart in FIG. 5. For example, the table management process is performed after the communication device 100 is connected to the communication network 510 and the communication network 520 and after the communication device 100 registers, with the routing table, a record indicating the router 210 as a default gateway and a record indicating the router 220 as a default gateway.

The controller 11 included in the communication device 100 first acquires communication target information (step S101). For example, the controller 11 causes the display 13 to display a screen for receiving an input of communication target information. The user refers to this screen and inputs the IP address of a communication target device and the identification information of a communication adapter used for communication with the communication target device. The controller 11 acquires the communication target information including the IP address of the communication target device and the identification information of the communication adapter. For multiple communication target devices, the controller 11 acquires communication target information for each of the communication target devices.

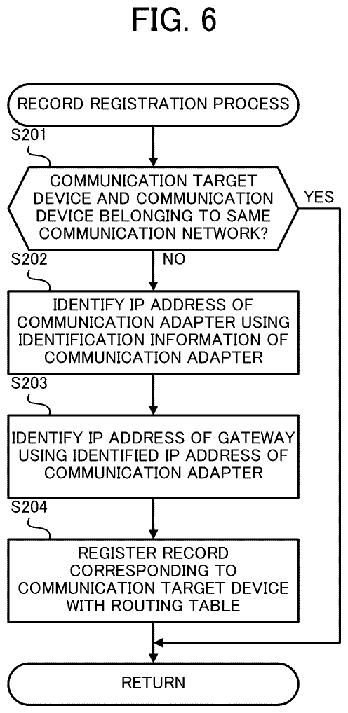

After ending the processing in step S101, the controller 11 performs a record registration process (step S102). The record registration process is described in detail below with reference to FIG. 6.

The controller 11 determines whether the communication target device and the communication device 100 belong to the same communication network (step S201). For example, the controller 11 determines whether the communication target device is connected to either the communication network 510 or the communication network 520. When determining that the communication target device and the communication device 100 belong to the same communication network (Yes in step S201), the controller 11 ends the record registration process.

When determining that the communication target device and the communication device 100 do not belong to the same communication network (No in step S201), the controller 11 identifies the IP address of the communication adapter using the identification information of the communication adapter included in the communication target information (step S202). For example, the controller 11 identifies the IP address of the communication adapter using the identification information of the communication adapter based on the correspondence information stored in the storage 12. When the identification information of the communication adapter is the IP address of the communication adapter, the processing in step S202 is not performed.

After ending the processing in step S202, the controller 11 identifies the IP address of the gateway using the identified IP address of the communication adapter (step S203). For example, the controller 11 identifies records corresponding to the default gateways selectively from the records registered with the routing table. The controller 11 identifies a record in which the communication adapter IP address matches the identified IP address of the communication adapter, selectively from the records corresponding to the default gateways. The controller 11 identifies the gateway IP address indicated by the identified record.

After ending the processing in step S203, the controller 11 registers the record corresponding to the communication target device with the routing table (step S204). This record includes the IP address of the communication target device included in the communication target information as the destination network ID, a full-bit subnet mask as the subnet mask, the IP address of the gateway identified in step S203 as the gateway IP address, and the IP address of the communication adapter identified in step S202 as the communication adapter IP address. After ending the processing in step S204, the controller 11 ends the record registration process.

After ending the record registration process in step S102, the controller 11 acquires specification information (step S103). For example, the controller 11 causes the display 13 to display a screen for receiving an input of specification information. The user refers to this screen and inputs specification information. More specifically, the user inputs, on this screen, information indicating a gateway specified as a default gateway or a communication adapter connectable to the gateway specified as a default gateway. The gateway specified as a default gateway is basically other than the gateways indicated by records individually registered with the routing table.

After ending the processing in step S103, the controller 11 deletes a record corresponding to the default gateway that is not specified (step S104). More specifically, the controller 11 deletes, from the routing table, records corresponding to the default gateways other than the default gateway specified by the specification information, selectively from the records corresponding to the default gateways registered with the routing table.

For example, when the router 220 is specified as a default gateway by the specification information, the record specifying the router 210 as a default gateway is deleted from the routing table, selectively from the record specifying the router 210 as a default gateway and the record specifying the router 220 as a default gateway. After ending the processing in step S104, the controller 11 ends the table management process.

In the present embodiment, the first record is registered with the routing table. The first record includes the IP address of the first communication device as the destination network ID, the full-bit subnet mask as the subnet mask, and the IP address of the first gateway or the identification information of the first communication adapter as the gateway IP address. The routing table is updated to indicate, as the default route, the second path through the second communication network.

In the present embodiment, for a communication target device with which the communication device 100 can communicate through the first communication network, the communication device 100 communicates with the communication target device through the first communication network based on the first record registered with the routing table. For a communication target device with which the communication device 100 can communicate through the second communication network, the communication device 100 communicates with the communication target device through the second communication network based on the default route indicated by the routing table.

In other words, in the present embodiment, the communication device registers, with the routing table, a record for communicating with a communication target device with which the communication device cannot communicate through a default gateway. This registration is performed based on the communication target information that can be easily identified by the user within the scope of TCP/IP implementation. The technique according to the present embodiment can thus appropriately determine a communication path with a simple structure without user effort.

In the present embodiment, the second record is deleted from the routing table selectively from the second record indicating the first path as a default route and the third record indicating the second path as a default route. The technique according to the present embodiment thus reduces the likelihood that multiple default routes are indicated and that the communication device 100 cannot communicate with a communication target device.

In the present embodiment, each of the first communication network and the second communication network is a LAN, and thus the IP address of the first gateway connected to the first communication network and the IP address of the second gateway connected to the second communication network can be easily identified. The technique according to the present embodiment thus does not involve a large change in the use of the routing table.

In the present embodiment, a record for communicating with the first communication device is generated based on the communication target information identifying the IP address of the first communication device and the IP address of the first gateway. The technique according to the present embodiment thus reduces user effort to generate the record for communicating with the first communication device.

In the present embodiment, the record for communicating with the first communication device is generated based on the communication target information including the IP address of the first communication device and the identification information of the first communication adapter. The technique according to the present embodiment thus further reduces user effort to generate the record for communicating with the first communication device.

### Embodiment 2

In Embodiment 1 described above, the user specifies a communication target device using the IP address of the communication target device when a record corresponding to the communication target device is added to the routing table. In the present embodiment described below, the user specifies a communication target device using the domain name system (DNS) hostname of the communication target device when a record corresponding to the communication target device is added to the routing table. The same components and functions as in Embodiment 1 are not described or are described briefly as appropriate.

Humans typically recognize devices with DNS hostnames represented by character strings more easily than with IP addresses represented by series of numbers. Thus, in the present embodiment, a network system has a structure that allows devices to be recognized with DNS hostnames. Each DNS hostname includes a domain name for identifying the network to which the device is connected and a short hostname for identifying the device. The DNS hostname including a domain name and a short hostname is referred to as a long hostname as appropriate. For example, when the short hostname is test1 and the domain name is aaa.test2, the long hostname is test1.aaa.test2.

To specify a communication target device using the DNS hostname, a query about an IP address corresponding to the DNS hostname is to be transmitted to a DNS server. Through this query, the IP address corresponding to the DNS hostname is acquired from the DNS server. This procedure is referred to as name resolution. The DNS server is basically provided for each communication network. To specify a communication target device using the DNS hostname, a query about the IP address of the communication target device is to be transmitted to the DNS server provided for the communication network to which the communication target device is connected.

When a communication device adds a record corresponding to a communication target device to the routing table, the communication target device is basically connected to the communication device with a gateway that is not set as a default gateway. Thus, the DNS server holding the IP address of the communication target device is also basically connected to the communication device with the gateway that is not set as a default gateway. Thus, the communication device is to add a record corresponding to the DNS server to the routing table before adding the record corresponding to the communication target device to the routing table.

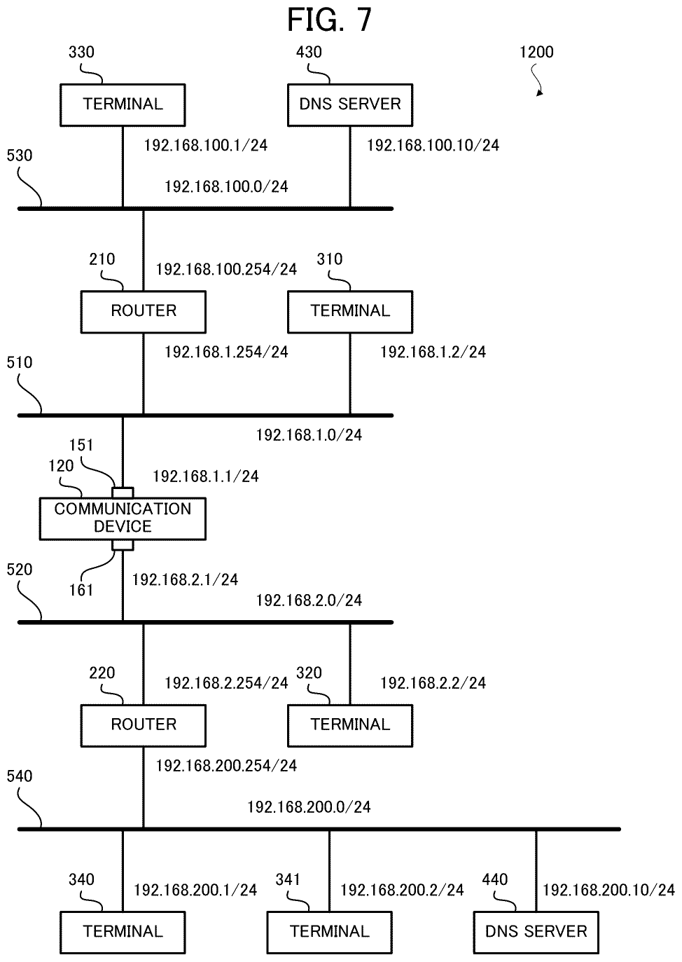

FIG. 7 is a block diagram of a network system 1200 according to the present embodiment. The network system 1200 includes a communication device 120, the router 210, the router 220, the terminal 310, the terminal 320, the terminal 330, the terminal 340, the terminal 341, a DNS server 430, a DNS server 440, the communication network 510, the communication network 520, the communication network 530, and the communication network 540. The communication device 120 physically has the same structure as the communication device 100.

The DNS server 430 allows conversion of a DNS hostname and an IP address. The DNS server 430 is connected to the communication network 530. The DNS server 430 can thus convert the DNS hostname and the IP address for the terminal 330 connected to the communication network 530. More specifically, the DNS server 430 converts the DNS hostname of the terminal 330 to the IP address of the terminal 330, and converts the IP address of the terminal 330 to the DNS hostname of the terminal 330.

The DNS server 440 allows conversion of a DNS hostname and an IP address. The DNS server 440 is connected to the communication network 540. The DNS server 440 can thus convert the DNS hostname and the IP address for each of the terminal 340 and the terminal 341 connected to the communication network 540.

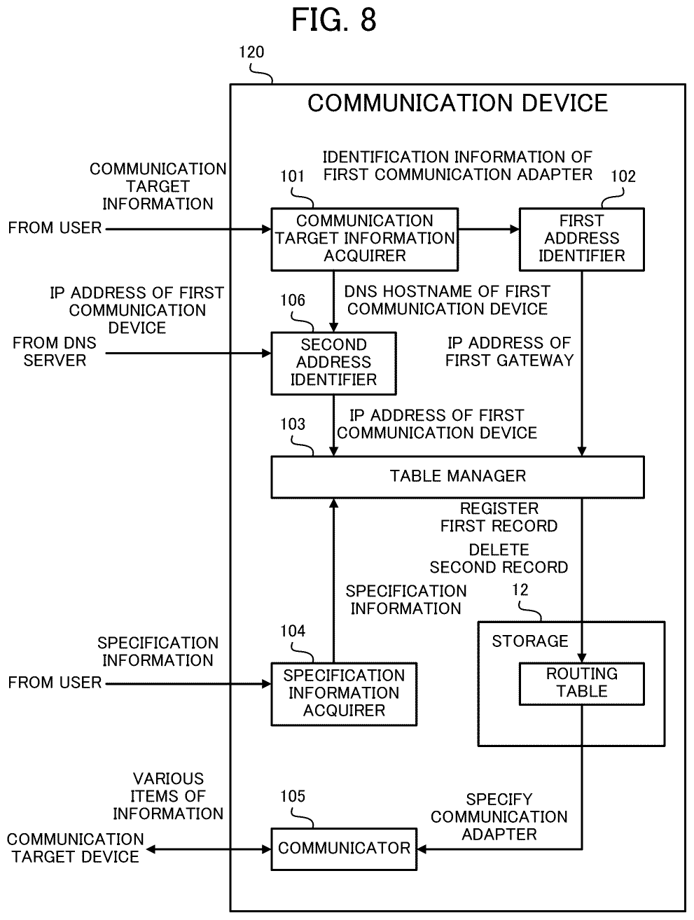

The functions of the communication device 120 are now described with reference to FIG. 8. The communication device 120 includes, as functional components, the communication target information acquirer 101, the first address identifier 102, the table manager 103, the specification information acquirer 104, the communicator 105, and a second address identifier 106. These functions are implemented by software, firmware, or a combination of software and firmware. The software and the firmware are described as programs that are stored in the ROM or the storage 12. When the CPU executes the programs stored in the ROM or the storage 12, the above functions are implemented.

The table manager 103 adds a fourth record to the routing table. The fourth record is used for communicating with a first DNS server. The first DNS server associates the IP address of the first communication device with the hostname of the first communication device, and is accessed by the communication device 120 to perform name resolution for the first communication device. The fourth record includes the IP address of the first DNS server as the destination network ID, a full-bit subnet mask as the subnet mask, and the IP address of the first gateway as the gateway IP address. The terminal 330 is an example of the first communication device. The DNS server 430 is an example of the first DNS server. The router 210 is an example of the first gateway.

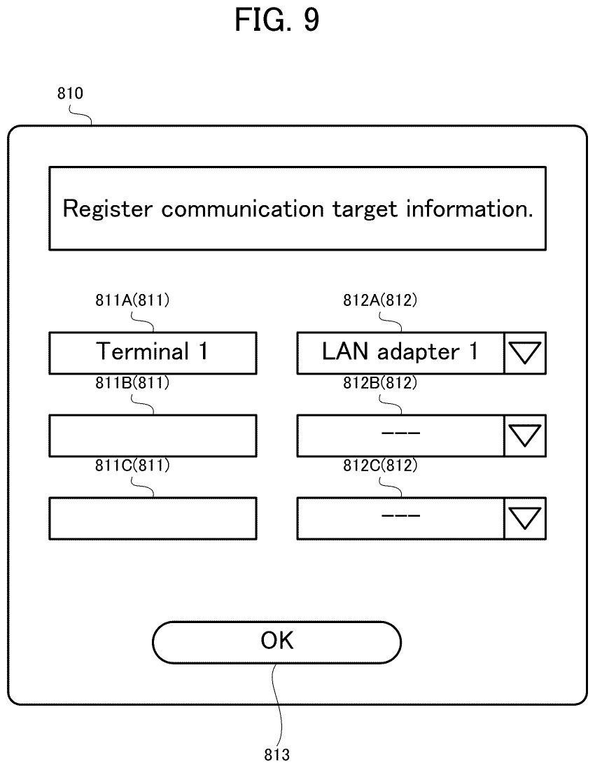

In the present embodiment, the communication target information acquired by the communication target information acquirer 101 includes the DNS hostname of the first communication device and the identification information of the first communication adapter. FIG. 9 illustrates a communication target information registration screen 810 presented by the communication target information acquirer 101 to acquire the communication target information.

The communication target information registration screen 810 is a screen for receiving an input of communication target information from the user. The communication target information registration screen 810 includes a text box 811A, a text box 811B, a text box 811C, a drop-down list 812A, a drop-down list 812B, a drop-down list 812C, and a button 813. The text box 811A, the text box 811B, and the text box 811C are collectively referred to as text boxes 811 as appropriate. The drop-down list 812A, the drop-down list 812B, and the drop-down list 812C are collectively referred to as drop-down lists 812 as appropriate.

The text boxes 811 and the drop-down lists 812 serve as an input interface for receiving communication target information from the user. A set of a text box 811 and a drop-down list 812 corresponds to a communication target device. Each text box 811 receives an input of the DNS hostname of the first communication device. FIG. 9 illustrates an example in which Terminal 1 is input as the DNS hostname of the first communication device. When the first communication device is the terminal 330, Terminal 1 is the DNS hostname of the terminal 330.

Each drop-down list 812 is operated to specify the identification information of a communication adapter used for communication with the first communication device. More specifically, in the present embodiment, the user selects the identification information of the communication adapter used for communication with the first communication device from candidates for the identification information of the communication adapter presented by the communication device 120. FIG. 9 illustrates an example in which LAN adapter 1 is specified as the identification information of the communication adapter used for communication with the first communication device. When the first communication device is the terminal 330, LAN adapter 1 is the identification information of the communication adapter 151. The button 813 is pressed when input of the communication target information is complete.

The second address identifier 106 accesses the first DNS server and identifies the IP address of the first communication device using the DNS hostname of the first communication device included in the communication target information. For example, when the first communication device is the terminal 330, the second address identifier 106 transmits the DNS hostname of the terminal 330 included in the communication target information to the DNS server 430. The second address identifier 106 then acquires the IP address of the terminal 330 from the DNS server 430. The second address identifier 106 is an example of second address identification means.

The table manager 103 sets, as the destination network ID in the first record, the IP address of the first communication device identified by the second address identifier 106. The table manager 103 sets, as the subnet mask in the first record, a full-bit subnet mask. The table manager 103 sets, as the gateway IP address in the first record, the IP address of the first gateway identified by the first address identifier 102.

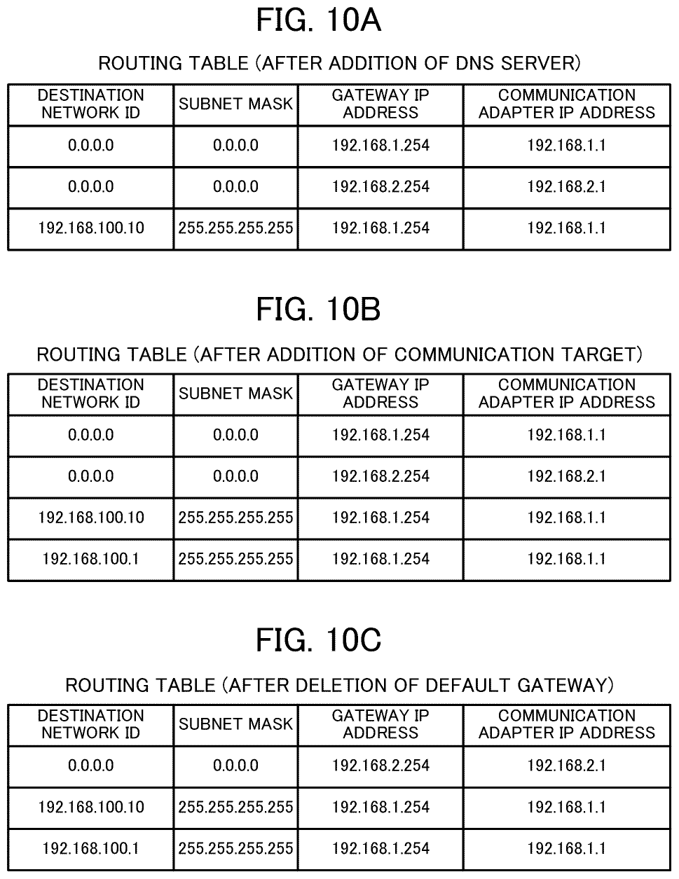

The details of the routing table updated by the table manager 103 are now described with reference to FIGS. 10A to 10C. FIG. 10A is the routing table after addition of a DNS server. As illustrated in FIG. 10A, the routing table after addition of a DNS server includes the second record indicating the first gateway as a default gateway, the third record indicating the second gateway as a default gateway, and the fourth record indicating the gateway and the communication adapter for communicating with the first DNS server. In FIG. 10A, the record in the first row is the second record, the record in the second row is the third record, and the record in the third row is the fourth record.

FIG. 10B is the routing table after addition of a communication target. As illustrated in FIG. 10B, the routing table after addition of a communication target includes the second record indicating the first gateway as a default gateway, the third record indicating the second gateway as a default gateway, the fourth record indicating the gateway and the communication adapter for communicating with the first DNS server, and the first record indicating the gateway and the communication adapter for communicating with the first communication device. In FIG. 10B, the record in the first row is the second record, the record in the second row is the third record, the record in the third row is the fourth record, and the record in the fourth row is the first record.

FIG. 10C is the routing table after deletion of a default gateway. As illustrated in FIG. 10C, the routing table after deletion of a default gateway includes the third record indicating the second gateway as a default gateway, the fourth record indicating the gateway and the communication adapter for communicating with the first DNS server, and the first record indicating the gateway and the communication adapter for communicating with the first communication device. In FIG. 10C, the record in the first row is the third record, the record in the second row is the fourth record, and the record in the third row is the first record.

The communication device 120 can refer to the routing table after addition of a DNS server to determine the communication adapter used for communication with the first DNS server. The communication device 120 can thus access the first DNS server and identify the IP address of the first communication device using the DNS hostname of the first communication device. The communication device 120 can generate the routing table after addition of a communication target.

Further, the communication device 120 deletes, from the routing table after addition of a communication target, the second record indicating the first gateway as a default gateway to generate the routing table after deletion of a default gateway. The communication device 120 can refer to the routing table after deletion of a default gateway to determine the communication adapter used for communication with the communication target device.

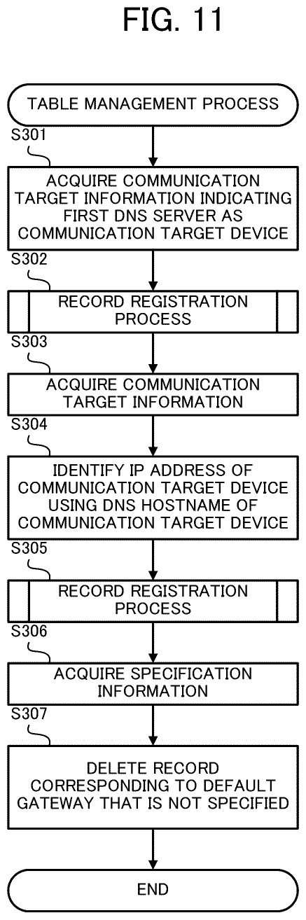

A table management process performed by the communication device 120 is now described with reference to the flowchart in FIG. 11. For example, the table management process is performed after the communication device 120 is connected to the communication network 510 and the communication network 520 and after the communication device 120 registers, with the routing table, a record indicating the router 210 as a default gateway and a record indicating the router 220 as a default gateway.

The controller 11 first acquires communication target information indicating the first DNS server as a communication target device (step S301). More specifically, the controller 11 acquires communication target information for identifying the IP address of the first DNS server and the IP address of the gateway used for communication with the first DNS server. When the IP address is assigned to each device by the DHCP server (not illustrated), the communication device 120 can acquire, from the DHCP server (not illustrated), the IP address of the first DNS server and the IP address of the gateway used for communication with the first DNS server. In this case, for example, the IP address of the first DNS server and the IP address of the gateway used for communication with the first DNS server are stored into the storage 12 included in the communication device 120. The controller 11 can thus acquire, from the storage 12, the communication target information indicating the first DNS server as a communication target device. In other words, the controller 11 can acquire the communication target information indicating the first DNS server as a communication target device, not from the user.

When the user manually sets IP addresses without using a DHCP server (not illustrated), the controller 11 is to acquire the communication target information indicating the first DNS server as a communication target device from the user. In this case, for example, an item for setting the IP address of the first DNS server may be added to the screen for setting the IP address of the first communication adapter.

After ending the processing in step S301, the controller 11 performs a record registration process (step S302). In the record registration process in step S302, a record used for communication with the first DNS server as a communication target device is added to the routing table. This record registration process is basically the same as the record registration process illustrated in FIG. 6.

After ending the processing in step S302, the controller 11 acquires communication target information (step S303). For example, the controller 11 presents the communication target information registration screen 810 illustrated in FIG. 9 and acquires, from the user, communication target information including the DNS hostname of the communication target device and the identification information of the communication adapter used for communication with the communication target device.

After ending the processing in step S303, the controller 11 identifies the IP address of the communication target device using the DNS hostname of the communication target device (step S304). For example, the controller 11 transmits the DNS hostname of the communication target device to the first DNS server and acquires the IP address of the communication target device from the first DNS server.

After ending the processing in step S304, the controller 11 performs a record registration process (step S305). This record registration process is basically the same as the record registration process illustrated in FIG. 6.

After ending the processing in step S305, the controller 11 acquires specification information (step S306). After ending the processing in step S306, the controller 11 deletes a record corresponding to the default gateway that is not specified (step S307). After ending the processing in step S307, the controller 11 ends the table management process.

In the present embodiment, the communication device 120 can communicate with the first DNS server after the fourth record for communicating with the first DNS server is registered with the routing table. Thus, in the present embodiment, the user can specify the first communication device using the DNS hostname of the first communication device rather than using the IP address of the first communication device in registering the first record for communicating with the first communication device with the routing table. The technique according to the present embodiment thus enhances user convenience.

### Embodiment 3

In Embodiment 1 described above, the communication device 100 is connected to two communication networks. In the present embodiment described below, a communication device 130 is connected to three communication networks. The same components and functions as in Embodiments 1 and 2 are not described or are described briefly as appropriate.

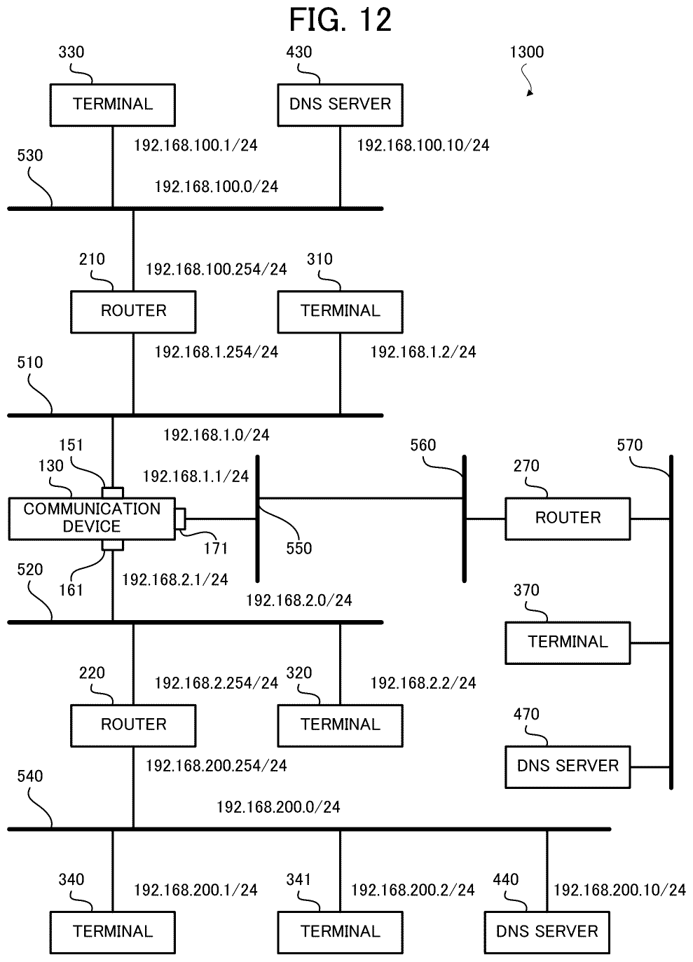

FIG. 12 is a block diagram of a network system 1300 according to the present embodiment. The network system 1300 includes the communication device 130, the router 210, the router 220, a router 270, the terminal 310, the terminal 320, the terminal 330, the terminal 340, the terminal 341, a terminal 370, the DNS server 430, the DNS server 440, a DNS server 470, the communication network 510, the communication network 520, the communication network 530, the communication network 540, a communication network 550, a communication network 560, and a communication network 570.

The communication device 130 physically includes the controller 11, the storage 12, the display 13, the operation receiver 14, the first communicator 15, the second communicator 16, and a third communicator (not illustrated).

The third communicator (not illustrated) communicates with devices connected to the communication network 550 under control of the controller 11. The third communicator (not illustrated) includes a communication adapter 171 for connecting to the communication network 550 based on the TCP/IP standard. The communication adapter 171 is a communication interface complying with a standard such as long-term evolution (LTE), 4th generation (4G), or 5th generation (5G).

The router 270 is a communication device for connecting the communication network 560 and the communication network 570. The router 270 relays data between the communication network 560 and the communication network 570. The router 270 includes a communication adapter (not illustrated) for connecting to the communication network 560 and a communication adapter (not illustrated) for connecting to the communication network 570.

The terminal 370 is connected to the communication network 570. The terminal 370 includes a communication adapter (not illustrated) for connecting to the communication network 570.

The DNS server 470 allows conversion of a DNS hostname and an IP address. The DNS server 470 is connected to the communication network 570. The DNS server 470 can thus convert the DNS hostname and the IP address for the terminal 370 connected to the communication network 570.

The communication network 510, the communication network 520, the communication network 530, the communication network 540, the communication network 550, the communication network 560, and the communication network 570 are different from one another. Each of the communication network 510, the communication network 520, the communication network 530, and the communication network 540 is, for example, a wireless LAN or a wired LAN at the facility.

The communication network 550 is, for example, a mobile phone network. The communication network 560 is, for example, the Internet. The communication network 570 is, for example, a wireless LAN or a wired LAN at another facility. The communication network 550 and the communication network 570 are connected to each other. FIG. 12 does not illustrate, for example, a base station or a switching center.

The communication network 510, the communication network 520, the communication network 530, the communication network 540, the communication network 550, the communication network 560, and the communication network 570 transmit and receive data based on the TCP/IP standard. In the present embodiment, the communication device 130 can communicate with a communication target device installed at the other facility through the communication network 550 as a mobile phone network and through the communication network 560 as the Internet.

In the present embodiment, the communication device 130 is connected to three communication networks, or specifically, the communication network 510, the communication network 520, and the communication network 550. Thus, in the present embodiment, one of the three paths may be set as a default route, selectively from the path through the communication network 510, the path through the communication network 520, and the path through the communication network 550, without the other paths being set as default routes.

In the present embodiment described below, the path through the communication network 550 is set as a default route. The communication device 130 can determine the path to be set as a default route based on the specification information acquired from the user by the specification information acquirer 104. The specification information includes information indicating, for example, a router corresponding to the path to be set as a default route and a communication adapter corresponding to the path to be set as a default route.

The user may set, as a default route, the path used for communication with a large number of unspecified communication target devices or the path used for communication with the largest number of communication target devices. For example, when the path through the communication network 550 is used for communication with more communication target devices than the path through the communication network 510 and the path through the communication network 520, the path through the communication network 550 may be set as a default route.

The communication device 130 is connected to the first communication network, the second communication network, and a third communication network. In the present embodiment, each of the first communication network and the third communication network is a LAN, and the second communication network is a mobile phone network. In the present embodiment, the first gateway connected to the first communication network and a third gateway connected to the third communication network are used, and the second gateway connected to the second communication network is not used. The communication device 130 includes the first communication adapter connectable to the first communication network, the second communication adapter connectable to the second communication network, and a third communication adapter connectable to the third communication network.

The communication network 510 is an example of the first communication network. The communication network 520 is an example of the third communication network. The communication network 550 is an example of the second communication network. The communication adapter 151 is an example of the first communication adapter. The communication adapter 161 is an example of the third communication adapter. The communication adapter 171 is an example of the second communication adapter. The router 210 is an example of the first gateway. The router 220 is an example of the third gateway.

The table manager 103 registers the first record for communicating with the first communication device with the routing table. The first communication device is connected to the communication device 130 with the first gateway. The table manager 103 registers a fifth record for communicating with a third communication device with the routing table. The third communication device is connected to the communication device 130 with the third gateway. The table manager 103 does not register a record for communicating with the second communication device with the routing table. The terminal 330 is an example of the first communication device. Each of the terminal 340 and the terminal 341 is an example of the third communication device. The terminal 370 is an example of the second communication device.

The first record includes the IP address of the first communication device as the destination network ID, a full-bit subnet mask as the subnet mask, and the IP address of the first gateway or the identification information of the first communication adapter as the gateway IP address. In the present embodiment, the first record includes the IP address of the first gateway as the gateway IP address. The table manager 103 can generate the first record based on the communication target information about the first communication device acquired from the user.

The fifth record includes the IP address of the third communication device as the destination network ID, a full-bit subnet mask as the subnet mask, and the IP address of the third gateway or the identification information of the third communication adapter as the gateway IP address. In the present embodiment, the fifth record includes the IP address of the third gateway as the gateway IP address. The table manager 103 can generate the fifth record based on the communication target information about the third communication device acquired from the user.

The table manager 103 updates the routing table to indicate the second path as a default route selectively from the first path, the second path, and a third path. The first path is a path through the first communication network. The second path is a path through the second communication network. The third path is a path through the third communication network.

For example, the table manager 103 registers the first record and the fifth record with the routing table, and deletes the second record and a sixth record from the routing table selectively from the second record, the third record, and the sixth record. The second record indicates the first path as a default route. The third record indicates the second path as a default route. The sixth record indicates the third path as a default route. In the present embodiment, the second record indicates the first gateway as a default gateway. The third record indicates the second communication adapter as a default gateway. The sixth record indicates the third gateway as a default gateway.

In the present embodiment, each of the first communication network and the third communication network is a LAN. Thus, the first gateway connected to the first communication network and the third gateway connected to the third communication network are used. For the first communication network and the third communication network, the default gateway and the default route are specified using a gateway. For the first communication network, for example, the IP address of the first gateway is used as the gateway IP address. Similarly, for the third communication network, the IP address of the third gateway is used as the gateway IP address.

In the present embodiment, the second communication network is a mobile phone network. Thus, the second gateway connected to the second communication network is not used. For the second communication network, the default gateway and the default route are specified using a communication adapter. For the second communication network, for example, the identification information of the second communication adapter is used as the gateway IP address. In other words, for the second communication network, the communication adapter replaces the gateway, without the gateway being used. For the second communication network, for example, the identification information of a communication adapter is used in the routing table, in place of the gateway IP address.

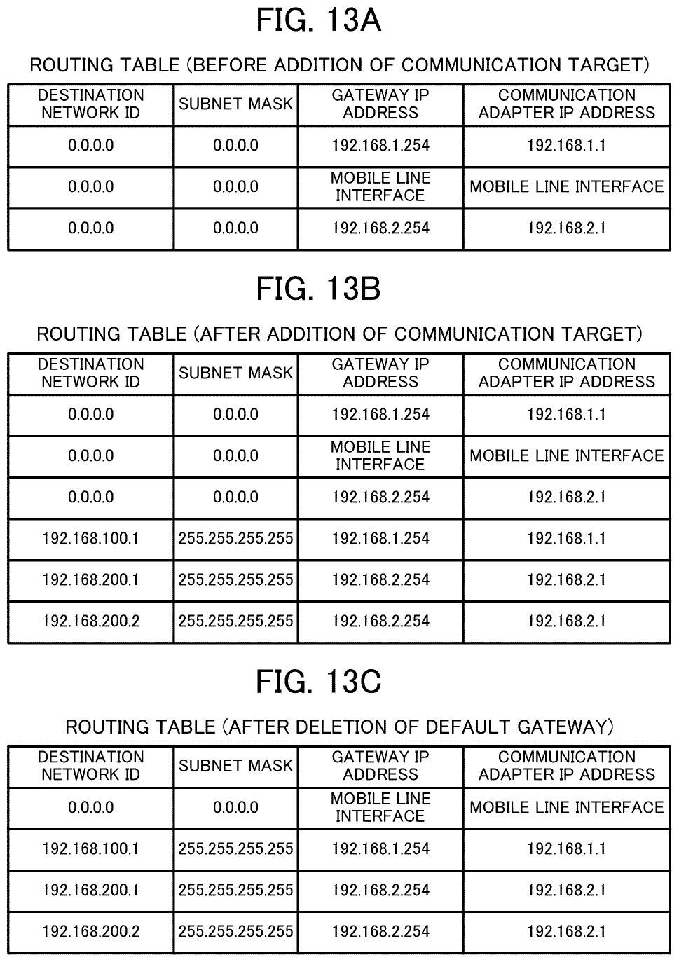

The details of the routing table updated by the table manager 103 are described with reference to FIGS. 13A to 13C. FIG. 13A is the routing table before addition of a communication target. As illustrated in FIG. 13A, the routing table before addition of a communication target includes the second record indicating the first gateway as a default gateway, the third record indicating the second communication adapter as a default gateway, and the sixth record indicating the third gateway as a default gateway. In FIG. 13A, the record in the first row is the second record, the record in the second row is the third record, and the record in the third row is the sixth record.

In the present embodiment, the gateway IP address and the communication adapter IP address are not provided for the second communication network. For the second communication network, the identification information of a communication adapter is used as the gateway IP address and the communication adapter IP address. In the present embodiment, as illustrated in FIG. 13A, each of the destination network ID and the subnet mask is 0.0.0.0, and each of the gateway IP address and the communication adapter IP address is a mobile line interface as the identification information of the communication adapter 171 in the third record.

FIG. 13B is the routing table after addition of a communication target. As illustrated in FIG. 13B, the routing table after addition of a communication target includes the second record indicating the first gateway as a default gateway, the third record indicating the second communication adapter as a default gateway, the sixth record indicating the third gateway as a default gateway, the first record indicating the gateway and the communication adapter for communicating with the first communication device, and the fifth record indicating the gateway and the communication adapter for communicating with the third communication device. In FIG. 13B, the record in the first row is the second record, the record in the second row is the third record, the record in the third row is the sixth record, the record in the fourth row is the first record, and the record in the fifth row and the record in the sixth row are each the fifth record.

FIG. 13C is the routing table after deletion of a default gateway. As illustrated in FIG. 13C, the routing table after deletion of a default gateway includes the third record indicating the second communication adapter as a default gateway, the first record indicating the gateway and the communication adapter for communicating with the first communication device, and the fifth record indicating the gateway and the communication adapter for communicating with the third communication device. In FIG. 13C, the record in the first row is the third record, the record in the second row is the first record, and the record in the third row and the record in the fourth row are each the fifth record.

The communication device 130 can refer to the routing table after deletion of a default gateway to determine the communication adapter used for communication with the communication target device. For example, the communication device 130 can communicate with the terminal 330 as the first communication device through the router 210 indicated as a gateway by the first record. The communication device 130 can also communicate with the terminal 340 or the terminal 341 as the third communication device through the router 220 indicated as a gateway by the fifth record. The communication device 130 can also communicate with the terminal 370 as the second communication device through the communication adapter 171 indicated as a default gateway by the third record.

In the present embodiment as well, the user can specify a communication target device using the DNS hostname of the communication target device similarly to Embodiment 2. Thus, the communication device 130 registers the fourth record for communicating with the first DNS server with the routing table before registering the first record for communicating with the first communication device with the routing table. The communication device 130 registers a record for communicating with a third DNS server with the routing table before registering the fifth record for communicating with the third communication device with the routing table.

The third DNS server associates the IP address of the third communication device with the DNS hostname of the third communication device. The DNS server 440 is an example of the third DNS server. The record for communicating with the third DNS server includes the IP address of the third DNS server as the destination network ID, a full-bit subnet mask as the subnet mask, and the IP address of the third gateway as the gateway IP address.

In the present embodiment, for a communication target device with which the communication device 130 can communicate through the first communication network, the communication device 130 communicates with the communication target device through the first gateway indicated by the first record registered with the routing table. For a communication target device with which the communication device 130 can communicate through the third communication network, the communication device 130 communicates with the communication target device through the third gateway indicated by the fifth record registered with the routing table. For a communication target device with which the communication device 130 can communicate through the second communication network, the communication device 130 communicates with the communication target device through the second communication adapter indicated as a default gateway by the routing table.

In other words, in the present embodiment, the communication device registers, with the routing table, a record for communicating with a communication target device with which the communication device cannot communicate through a default gateway. This registration is performed based on the communication target information that can be easily identified by the user within the scope of TCP/IP implementation. The technique according to the present embodiment can thus appropriately determine a communication path with a simple structure without user effort when the communication device 130 is connectable to three communication networks.

In the present embodiment, the second record and the sixth record are deleted from the routing table selectively from the second record indicating the first path as a default route, the third record indicating the second path as a default route, and the sixth record indicating the third path as a default route. The technique according to the present embodiment thus reduces the likelihood that multiple default routes are indicated and that the communication device 130 cannot communicate with a communication target device.

In the present embodiment, each of the first communication network and the third communication network is a LAN, and the second communication network is a mobile phone network. For the second communication network, the second communication adapter is used as a gateway. The technique according to the present embodiment thus does not involve a large change in the use of the routing table.

### Embodiment 4

In Embodiment 1, the process of updating the routing table is described in detail to avoid communication failure resulting from duplicate registration of multiple default gateways. In the present embodiment, the software for implementing the above process is described in detail. The same components and functions as in Embodiments 1 to 3 are not described or are described briefly as appropriate.

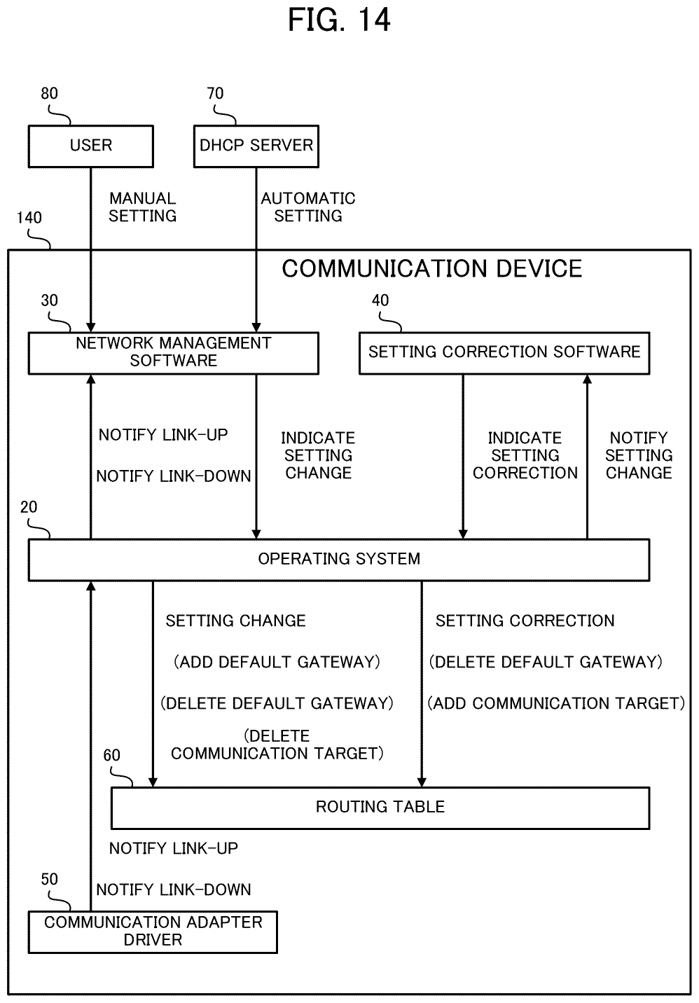

As illustrated in FIG. 14, a communication device 140 according to the present embodiment includes, as software, an operating system 20, network management software 30, setting correction software 40, and a communication adapter driver 50. The communication device 140 has the same hardware configuration as the communication device 100.

The operating system 20 is basic software for managing the overall computer system in the communication device 140. The operating system 20 is software including, for example, basic functions for managing and controlling the communication device 140 and basic functions common to many software items. The operating system 20 manages a routing table 60 with which the network setting of the communication device 140 is registered.

As illustrated in Embodiment 1, the routing table 60 is a table with which records are registered, and each record includes the destination network ID, the subnet mask, and the gateway IP address. The routing table 60 is stored in, for example, the storage 12. When the operating system 20 detects a change in the network setting performed by the network management software 30, the operating system 20 notifies the setting correction software 40 of the change in the network setting.

The network management software 30 manages the network setting of the communication device 140 in cooperation with the operating system 20. The network management software 30 is resident software that is activated immediately after the communication device 140 is activated. The network management software 30 updates the routing table 60 to change the network setting of the communication device 140. The network setting performed by the network management software 30 includes automatic setting with a DHCP server 70 and manual setting with a user 80. The network setting of the communication device 140 is hereafter simply referred to as a network setting as appropriate.

The setting correction software 40 is application software for correcting the network setting of the communication device 140 in cooperation with the operating system 20. Application software operates on the operating system 20 and is developed and used for specific functions and purposes. The setting correction software 40 is resident software that is activated immediately after the communication device 140 is activated. The setting correction software 40 can constantly receive various notifications from the operating system 20. The setting correction software 40 updates the routing table 60 to correct the network setting of the communication device 140.

When detecting duplicate registration of default gateways, the setting correction software 40 deletes an unintended default gateway and registers an intended communication target. More specifically, when receiving a notification of a change in the network setting from the operating system 20, the setting correction software 40 determines whether the network setting indicates multiple gateways as default gateways. When determining that multiple gateways are indicated as default gateways, the setting correction software 40 corrects the network setting to indicate the specified gateway alone as a default gateway selectively from the multiple gateways.

The setting correction software 40 can correct the network setting to indicate the specified gateway alone as a default gateway to allow communication between the communication device 140 and the first communication device. The first communication device is connected to the communication device 140 with the first gateway of the multiple gateways other than the specified gateway. Correcting the network setting to indicate the specified gateway alone as a default gateway corresponds to correcting the network setting to indicate a specified path through the specified gateway as a default route.

When the setting correction software 40 receives a notification of a change in the network setting from the operating system 20 and the routing table 60 indicates the first path and the second path as default routes, the setting correction software 40 registers the first record with the routing table 60 and updates the routing table 60 to indicate the second path as a default route. The second path is the specified path described above. The first path is a path through the first gateway and without being through the specified gateway. In Embodiment 1, the specified gateway is the router 220, the first path is a path through the router 210, and the second path is a path through the router 220.

The first record is as described in Embodiment 1. More specifically, the first record includes the IP address of the first communication device as the destination network ID. The first record includes a full-bit subnet mask as the subnet mask. The first record includes, as the gateway IP address, the IP address of the first gateway or the identification information of the first communication adapter for connecting the communication device 140 to the first gateway selectively from the multiple communication adapters. In Embodiment 1, the first communication device is the terminal 330, and the first communication adapter is the communication adapter 151.

The setting correction software 40 registers, with a recovery file stored in the storage 12, information indicating the first record and information indicating the second path that is the specified path as a default route. When the network management software 30 deletes the first record from the routing table 60 and updates the routing table 60 to indicate multiple paths including the first path and the second path as default routes, the setting correction software 40 performs a recovery process. In the recovery process, the setting correction software 40 registers the first record with the routing table 60 and updates the routing table 60 to indicate the second path that is the specified path as a default route based on the recovery file.

The communication adapter driver 50 is a device driver for the communication adapter 151 and the communication adapter 161. More specifically, the communication adapter driver 50 is software to allow the operating system 20 to control the communication adapter 151 and the communication adapter 161 that are hardware components included in the communication device 140. For example, the communication adapter driver 50 transmits and receives packets, provides a notification of link-up, and provides a notification of link-down. Link-up refers to the communication device 140 being connected to another device to allow communication between the communication device 140 and the other device. Link-down refers to the communication device 140 being disconnected from another device not to allow communication between the communication device 140 and the other device.

The procedure for correcting the network setting performed by the setting correction software 40 after the network setting is changed by the network management software 30 is now described in detail with reference to FIG. 14.

First, the network setting performed automatically with the DHCP is described. In this case, the network management software 30 functions as a DHCP client, and automatically performs network setting based on information received from the DHCP server 70 as a DHCP server. For the automatic setting in the communication network 510, for example, the network management software 30 receives the IP address of the communication device 140 in the communication network 510 from the DHCP server 70, and registers the received IP address of the communication device 140.

The network management software 30 registers, with the routing table 60, the router 210 that is a default gateway specified by the DHCP server 70. When another default gateway is already registered with the routing table 60, the network management software 30 registers a new default gateway with the routing table 60. The other default gateway is, for example, the router 220 in the communication network 520.

The network setting is updated using the operating system 20. More specifically, the network management software 30 and the setting correction software 40 can update the network setting using commands prepared by the operating system 20. Examples of the commands include a command for registering a communication adapter IP address, a command for deleting a communication adapter IP address, a command for adding a default gateway, a command for deleting a default gateway, a command for adding a communication target, a command for deleting a communication target, and a command for acquiring a registered default gateway.

The operating system 20 provides a notification of any update to the network setting. An update to the routing table 60 corresponds to an update to the network setting. Thus, the operating system 20 provides a notification of any update to the routing table 60. For example, the operating system 20 notifies the setting correction software 40 of any update to the routing table 60 performed by the network management software 30.

The notification to be provided by the operating system 20 may be selected as appropriate. For example, the notification may indicate an update to the routing table 60, addition of a default gateway to the routing table 60, or the IP address of a default gateway added to the routing table 60.

When receiving, from the operating system 20, a notification indicating addition of a default gateway to the routing table 60, the setting correction software 40 determines whether duplicate registration of default gateways occurs. For example, the setting correction software 40 uses the command for acquiring a default gateway registered with the routing table 60 to identify a default gateway registered with the routing table 60. When determining that multiple default gateways are registered with the routing table 60, the setting correction software 40 performs the table management process described in Embodiment 1.

In the table management process, the setting correction software 40 acquires, from the user, specification information specifying a default gateway and communication target information indicating a communication target with which communication is allowed through the default gateway that is not specified. In the table management process, the setting correction software 40 deletes the default gateway that is not specified, and adds the communication target with which communication is allowed through the default gateway that is not specified.

More specifically, the setting correction software 40 uses the command for deleting a default gateway to delete, from the routing table 60, the default gateway that is not specified. The setting correction software 40 also uses the command for adding a communication target to add, to the routing table 60, the communication target with which communication is allowed through the default gateway that is not specified.

The network setting performed manually by the user 80 is now described. The user 80 is, for example, a network manager. In this case, the network management software 30 performs network setting based on information acquired from the user 80. For example, the network management software 30 updates a setting file based on information acquired from the user 80, and updates the routing table 60 based on the setting file. The setting file holds the network setting and is stored in, for example, the storage 12.

When, for example, the setting file is prepared for each communication adapter, the default route is specified for each setting file. In this case, the network management software 30 registers multiple default gateways with the routing table 60. The operating system 20 notifies the setting correction software 40 of addition of a default gateway to the routing table 60. When receiving, from the operating system 20, a notification indicating addition of a default gateway to the routing table 60, the setting correction software 40 determines whether duplicate registration of default gateways occurs. When determining that multiple default gateways are registered with the routing table 60, the setting correction software 40 performs the table management process described in Embodiment 1.

With either the automatic setting or the manual setting, the routing table 60 having duplicate registration of default gateways can be corrected appropriately. More specifically, the default gateway that is not specified is deleted from the routing table 60, and the communication target with which communication is allowed through the default gateway that is not specified is registered with the routing table 60. This reduces communication failure.

Resetting of the network setting through link-down and link-up is now described. In the example described below, link-down and link-up occur for the communication adapter 151 connected to the router 210 that is not specified as a default gateway.

When a communication cable (not illustrated) is disconnected from the communication adapter 151, a notification of link-down of the communication adapter 151 is provided to the operating system 20 from the communication adapter driver 50. In this case, the operating system 20 notifies the network management software 30 of the link-down. When receiving the notification of link-down from the operating system 20, the network management software 30 deletes information about the link-down communication adapter 151 from the network setting. For example, the network management software 30 uses the command for deleting an IP address to delete the IP address of the communication adapter 151.

The network management software 30 uses the command for deleting a communication target to delete, from the routing table 60, the communication target with which communication is allowed through the communication adapter 151. Deleting the communication target corresponds to deleting the first record. The operating system 20 may notify the setting correction software 40 of the deletion of the communication target from the routing table 60. In this state, duplicate registration of default gateways has not occurred. Thus, the setting correction software 40 does not correct the routing table 60 when receiving the deletion notification from the operating system 20.

When, for example, the communication cable (not illustrated) is inserted into the communication adapter 151, a notification of link-up of the communication adapter 151 is provided to the operating system 20 from the communication adapter driver 50. In this case, the operating system 20 notifies the network management software 30 of the link-up. When receiving the notification of link-up from the operating system 20, the network management software 30 adds information about the link-up communication adapter 151 to the network setting.

When, for example, the automatic setting with the DHCP is used, the network management software 30 acquires various items of information from the DHCP server 70 and updates the routing table 60 based on the acquired information. More specifically, for example, the network management software 30 uses the command for registering an IP address to add the IP address of the communication adapter 151. The network management software 30 also uses the command for adding a default gateway to add, to the routing table 60, the router 210 connected to the communication adapter 151 as a default gateway.

When, for example, the manual setting is used, the network management software 30 acquires information written in the setting file stored in the storage 12, and updates the network setting based on the acquired information. More specifically, for example, the network management software 30 uses the command for registering an IP address to register the IP address of the communication adapter 151. The network management software 30 also uses the command for adding a default gateway to add, to the routing table 60, the router 210 connected to the communication adapter 151 as a default gateway.

When the default gateway is registered with the routing table 60, the operating system 20 notifies the setting correction software 40 of the registration of the default gateway with the routing table 60. When receiving the notification of registration of the default gateway from the operating system 20, the setting correction software 40 determines whether duplicate registration of default gateways occurs. When determining that duplicate registration of default gateways occurs, the setting correction software 40 deletes, from the routing table 60, the default gateway that is not specified and adds, to the routing table 60, the communication target with which communication is allowed through the default gateway that is not specified.

The setting correction software 40 can update the routing table 60 using the recovery file when the network structure after link-up has no difference from the network structure before link-down. The network structure may be the structure of a communication adapter included in the communication device 140. More specifically, when the communication adapter included in the communication device 140 after link-up is the same as the communication adapter included in the communication device 140 before link-down, the setting correction software 40 may determine that the network structure after link-up has no difference from the network structure before link-down.

The setting correction software 40 can write the network structure, specification information, and communication target information into the recovery file in the table management process performed before link-down. In other words, the recovery file stores, for example, the network structure before link-down, specification information before link-down, and communication target information before link-down. The setting correction software 40 can recover the details of the routing table 60 based on the information written in the recovery file.

More specifically, the setting correction software 40 deletes, from the routing table 60, a default gateway other than the default gateway specified by the specification information written in the recovery file. The setting correction software 40 adds, to the routing table 60, the communication target indicated by the communication target information written in the recovery file. This operation can automatically recover the details of the routing table 60 when link-down and link-up occur, and reduces communication failure.

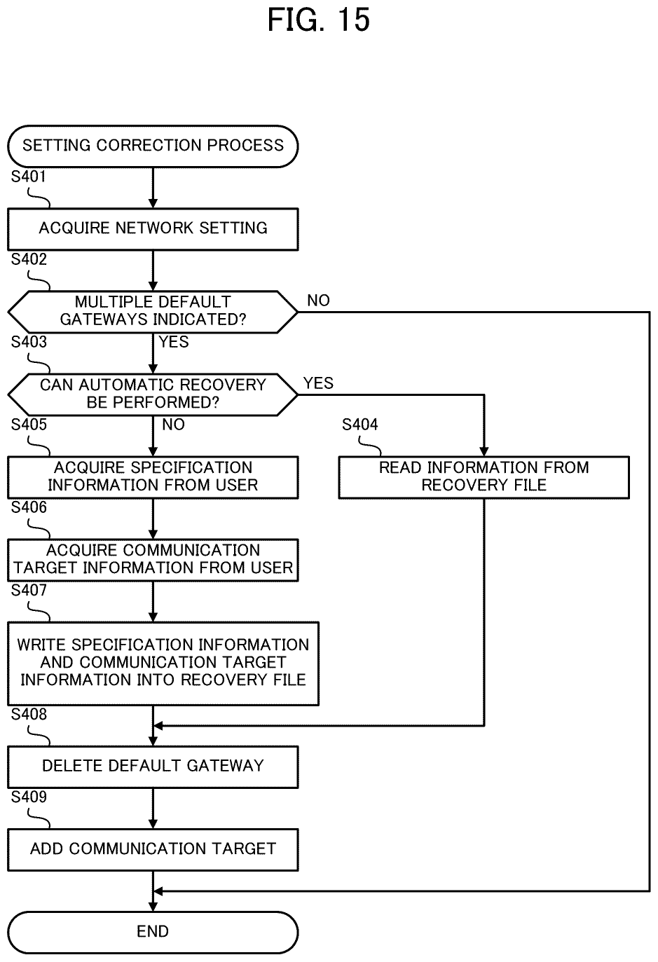

A setting correction process performed by the communication device 140 is now described with reference to the flowchart in FIG. 15. The setting correction process is implemented by the setting correction software 40. The setting correction process is performed in response to, for example, a notification of a change in the network setting provided to the setting correction software 40 from the operating system 20.

The controller 11 first acquires the network setting (step S401). For example, the controller 11 uses the command for acquiring a registered default gateway to identify the default gateway registered with the routing table 60. After ending the processing in step S401, the controller 11 determines whether multiple default gateways are indicated (step S402). In other words, the controller 11 determines whether multiple default gateways are registered with the routing table 60.

When determining that multiple default gateways are not indicated (No in step S402), the controller 11 ends the setting correction process. When determining that multiple default gateways are indicated (Yes in step S402), the controller 11 determines whether automatic recovery can be performed (step S403). For example, the controller 11 may determine that automatic recovery can be performed when the recovery file is stored in the storage 12. In some embodiments, for example, the controller 11 may determine that automatic recovery can be performed when the current network structure has no difference from the network structure recorded in the recovery file.

When determining that automatic recovery can be performed (Yes in step S403), the controller 11 reads information from the recovery file (step S404). More specifically, the controller 11 reads specification information and communication target information from the recovery file. When determining that automatic recovery cannot be performed (No in step S403), the controller 11 acquires specification information from the user 80 (step S405). In other words, the controller 11 receives a default gateway specified by the user 80.

After ending the processing in step S405, the controller 11 acquires communication target information from the user 80 (step S406). In other words, the controller 11 receives a communication target, specified by the user 80, with which communication is allowed through the gateway that is not specified as a default gateway. After ending the processing in step S406, the controller 11 writes the specification information and the communication target information into the recovery file (step S407).

After ending the processing in step S404 or S407, the controller 11 deletes the default gateway (step S408). More specifically, the controller 11 uses the command for deleting a default gateway to delete, from the routing table 60, the default gateway that is not specified by the specification information.

After ending the processing in step S408, the controller 11 adds the communication target (step S409). More specifically, the controller 11 uses the command for adding a communication target to add, to the routing table 60, the communication target indicated by the communication target information. After ending the processing in step S409, the controller 11 ends the setting correction process.

When multiple default gateways are registered with the routing table 60, the communication device 140 cannot easily identify a communication adapter for communicating with the communication target device. When the communication device 140 selects an erroneous communication adapter, the communication device 140 cannot communicate with the communication target device, causing communication failure. As a technique responding to such an issue, Patent Literature 1 describes a technique for determining a communication path using a dummy address and determining a communication adapter used for communication.

However, the technique described in Patent Literature 1 diverges greatly from the implementation of TCP/IP and involves complicated processing. A technique is thus awaited for avoiding continued duplicate registration of multiple default gateways. In other words, a technique is awaited for reducing communication failure with a simple structure. The technique according to the present embodiment can reduce communication failure with a simple structure.

More specifically, in the present embodiment, when the network setting indicates multiple gateways as default gateways, the network setting is corrected to indicate the specified gateway alone as a default gateway selectively from the multiple gateways. The technique according to the present embodiment can avoid continued duplicate registration of multiple default gateways. Thus, the technique according to the present embodiment can reduce communication failure with a simple structure.

With the method according to the present embodiment, the setting correction software 40 can promptly eliminate duplicate registration of multiple default gateways when the multiple default gateways are registered in a duplicate manner by the network management software 30. The method may include correcting the operating system 20 or the network management software 30 to reduce duplicate registration of multiple default gateways.

However, correcting the operating system 20 can affect various processes and can be difficult. The network management software 30 is deeply associated with the operating system 20. Correcting the network management software 30 corresponds to correcting implementation of the DHCP. Thus, correcting the network management software 30 can also be difficult. In contrast, the method according to the present embodiment uses the setting correction software 40 without correcting the operating system 20 or the network management software 30. Such software is easy to develop.

In the present embodiment, the setting correction software 40 can promptly detect and eliminate duplicate registration of multiple default gateways when receiving a notification of a change in the network setting from the operating system 20. In the present embodiment, any duplicate registration of multiple default gateways lasts for a notably short time, and communication failure is far less likely to occur.

In the present embodiment, when duplicate registration of multiple default gateways is eliminated, the network setting is corrected to allow communication between the communication device 140 and the first communication device connected to the communication device 140 with the gateway that is not specified as a default gateway. More specifically, when the routing table 60 is updated to indicate the specified path through the specified gateway as a default route, the first record is registered with the routing table 60 to allow communication between the communication device 140 and the first communication device. Thus, the technique according to the present embodiment allows communication using multiple communication adapters with less communication failure.

In the present embodiment, the details of the routing table 60 are recovered automatically based on the recovery file. More specifically, in the present embodiment, when the first record is deleted from the routing table 60 and the routing table 60 is updated to indicate multiple paths as default routes, the first record is registered with the routing table 60 and the routing table 60 is updated to indicate the specified path as a default route based on the recovery file. The technique according to the present embodiment thus reduces communication failure without user effort.

### Embodiment 5

In Embodiment 2 described above, the path through the mobile phone network selectively from the two LANs and the mobile phone network is set as a default route. In the present embodiment described below, a path through a LAN selectively from the LANs and the mobile phone network is set as a default route. The same components and functions as in Embodiments 1 to 4 are not described or are described briefly as appropriate.

Whether the path through a LAN is set as a default route or whether the path through the mobile phone network is set as a default route may be selected as appropriate. For example, the default route may be set based on the level of difficulty in acquiring the IP address of a communication target device. More specifically, for example, when the communication device has difficulty in acquiring the IP address of a communication target device connected through the mobile phone network, the path through the mobile phone network may be set as a default route. When, for example, the communication device has difficulty in acquiring the IP address of a communication target device connected through a LAN, the path through the LAN may be set as a default route.

In the present embodiment described below, the path through a LAN is set as a default route when the communication device has difficulty in acquiring the IP address of a communication target device connected through the LAN. The communication device may have difficulty in acquiring the IP address of a communication target device connected through a LAN when, for example, the communication target device is connected to the LAN with a virtual private network (VPN).

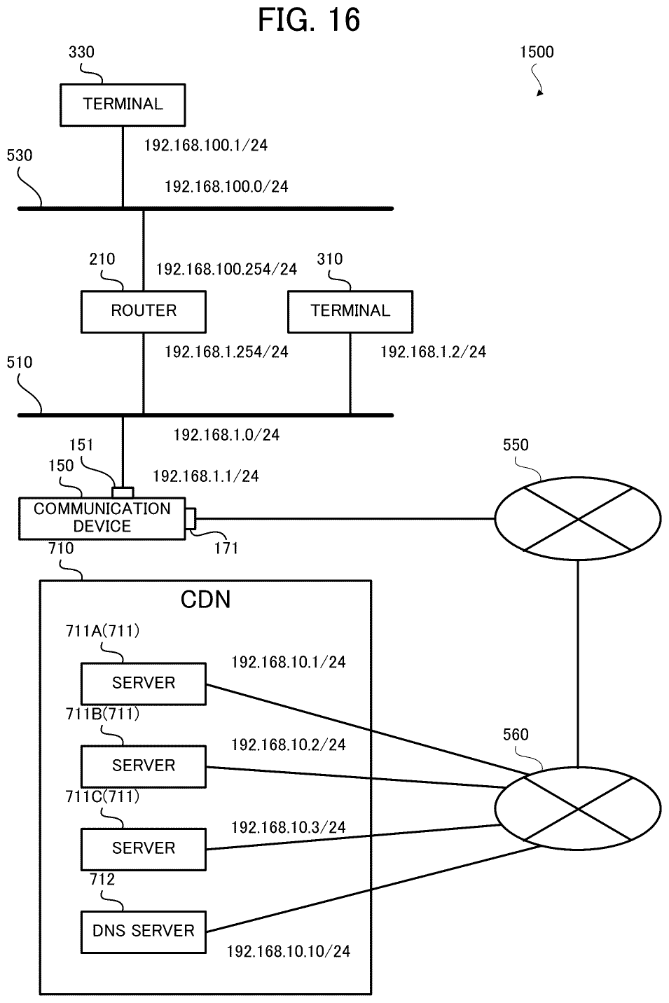

FIG. 16 is a block diagram of a network system 1500 according to the present embodiment. The network system 1500 includes a communication device 150, the router 210, the terminal 310, the terminal 330, a server 711A, a server 711B, a server 711C, a DNS server 712, the communication network 510, the communication network 530, the communication network 550, and the communication network 560.

The server 711A, the server 711B, and the server 711C are a group of distribution servers that store the same content in a content delivery network (CDN). The CDN is an optimized network for delivering web content through the Internet. The CDN includes multiple distribution servers that store the same content. The CDN is a system with redundant servers for, for example, reducing a server load and protecting against a denial-of-service (DOS) attack.

In the present embodiment, a CDN 710 includes the server 711A, the server 711B, the server 711C, and the DNS server 712. The CDN 710 may include four or more servers 711. The server 711A, the server 711B, and the server 711C are origin servers that store original content or cache servers that store copies of the original content. The server 711A, the server 711B, and the server 711C have the same DSN hostname. The communication device 150 acquires content from one of the server 711A, the server 711B, or the server 711C. The server 711A, the server 711B, and the server 711C are collectively referred to as servers 711. Each server 711 includes a communication adapter (not illustrated) for connecting to the communication network 560.

The DNS server 712 allows conversion of a DNS hostname and an IP address. The DNS server 712 performs name resolution for the servers in the CDN 710. More specifically, the DNS server 712 performs name resolution for the server 711A, the server 711B, and the server 711C. For example, when the DNS server 712 receives the DNS hostname of the server 711, the DNS server 712 transmits the IP address of the server 711 to provide content, or specifically, one of the server 711A, the server 711B, or the server 711C. More specifically, when the DNS server 712 receives the DNS hostname of the server 711, the DNS server 712 transmits one of the IP address of the server 711A, the IP address of the server 711B, or the IP address of the server 711C.

The method for determining the server 711 to provide content may be selected as appropriate. For example, the DNS server 712 determines the server 711 to provide content based on the communication device requesting the name resolution or based on the time at which the name resolution is requested. The DNS server 712 includes a communication adapter (not illustrated) for connecting to the communication network 560.

Each of the communication network 510 and the communication network 530 is, for example, a wireless LAN or a wired LAN at the facility. The communication network 550 is, for example, a mobile phone network. The communication network 560 is, for example, the Internet. FIG. 16 does not illustrate, for example, a base station or a switching center. The communication network 510, the communication network 530, the communication network 550, and the communication network 560 transmit and receive data based on the TCP/IP standard.

In the present embodiment, the path through the communication network 510 is set as a default route. In other words, the communication network 510 is an example of the second communication network. The communication network 550 is an example of the first communication network. The communication adapter 151 is an example of the second communication adapter. The communication adapter 171 is an example of the first communication adapter.

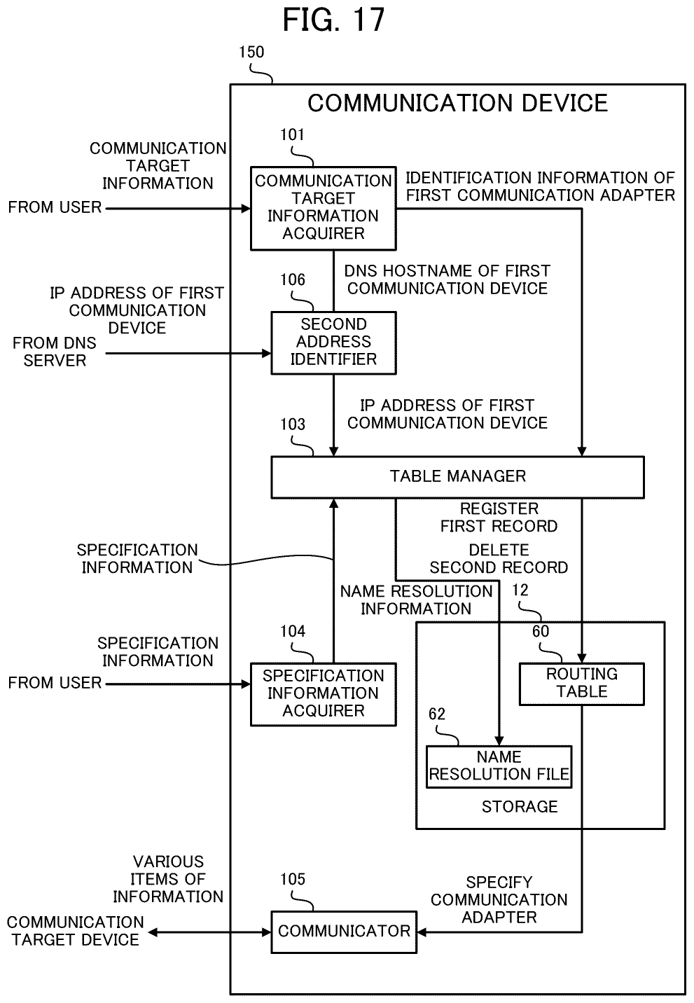

The functions of the communication device 150 are now described with reference to FIG. 17. The communication device 150 includes, as functional components, the communication target information acquirer 101, the table manager 103, the specification information acquirer 104, the communicator 105, and the second address identifier 106.

The communication target information acquirer 101 acquires communication target information from the user. In the present embodiment, the communication target information includes the DNS hostname of the first communication device and the identification information of the first communication adapter. In the present embodiment, the first communication device is each of the servers 711.

The table manager 103 manages the routing table 60. The table manager 103 manages a name resolution file 62. The name resolution file 62 is used to resolve the name of the first communication device without accessing the DNS server. In other words, the name resolution file 62 is used to identify the IP address of the first communication device using the DNS hostname of the first communication device. The name resolution file 62 contains name resolution information including, in a manner associated with each other, the DNS hostname of the first communication device and the IP address of the first communication device. The name resolution file 62 is, for example, a hosts file. The hosts file is a database of DNS hostnames in a computer using TCP/IP. The hosts file is a text file describing the correspondence between IP addresses and DNS hostnames.

In the present embodiment, the information in the routing table 60 is synchronized with the information in the name resolution file 62. More specifically, when the table manager 103 writes the first record including the IP address of the first communication device into the routing table 60, the table manager 103 writes name resolution information into the name resolution file 62. The name resolution information includes, in a manner associated with each other, the DNS hostname of the first communication device and the IP address of the first communication device. This ensures that the IP address of the first communication device included in the name resolution information in the name resolution file 62 is included in the first record in the routing table 60. This structure allows the communication device 150 to communicate with the first communication device using the IP address of the first communication device acquired by referring to the name resolution file 62.

The first communication device is specified by, for example, the user or software typically using the DNS hostname rather than using the IP address. Thus, the communication device 150 is to access the first DNS server that associates the IP address of the first communication device with the hostname of the first communication device. The communication device 150 is thus to register a record corresponding to the first DNS server with the routing table 60.

Thus, the table manager 103 adds the fourth record for communicating with the first DNS server to the routing table 60. The fourth record includes the IP address of the first DNS server as the destination network ID, a full-bit subnet mask as the subnet mask, and the identification information of the first communication adapter as the gateway IP address. The DNS server 712 is an example of the first DNS server. The communication adapter 171 is an example of the first communication adapter.

The specification information acquirer 104 acquires specification information from the user. In the present embodiment, the specification information includes the IP address of the router 210 specified as a default gateway. The second address identifier 106 accesses the first DNS server and identifies the IP address of the first communication device using the DNS hostname of the first communication device included in the communication target information.

The table manager 103 registers the first record with the routing table 60. The first record includes, as the destination network ID, the IP address of the first communication device identified by the second address identifier 106, and includes the identification information of the first communication adapter as the gateway IP address. The table manager 103 also deletes, from the routing table 60, the second record indicating the first communication adapter as a default gateway.

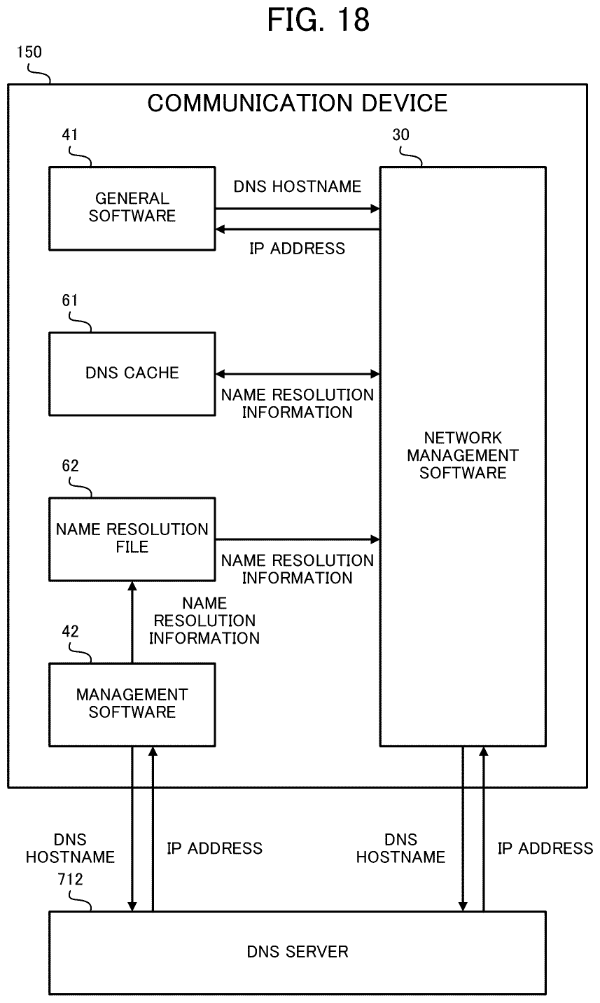

Communication between the communication device 150 and the first communication device achieved through synchronization between the information in the routing table 60 and the information in the name resolution file 62 is now described with reference to FIG. 18. As illustrated in FIG. 18, the communication device 150 includes the network management software 30, general software 41, management software 42, a DNS cache 61, and the name resolution file 62.

The network management software 30 manages the network setting of the communication device 150 in cooperation with the operating system 20. The general software 41 is application software other than the management software 42.

The management software 42 is application software for managing the routing table 60 and the name resolution file 62. For example, the communication target information acquirer 101, the table manager 103, the specification information acquirer 104, the communicator 105, and the second address identifier 106 may be implemented as the management software 42.

The DNS cache 61 temporarily stores the result of name resolution performed by the DNS server 712. In other words, the DNS cache 61 temporarily stores name resolution information acquired by the network management software 30 accessing the DNS server 712.

The general software 41 basically performs name resolution using the network management software 30. More specifically, the general software 41 provides a DNS hostname to the network management software 30 and acquires an IP address corresponding to the DNS hostname from the network management software 30. The network management software 30 acquires the IP address corresponding to the DNS hostname from the name resolution file 62, the DNS cache 61, or the DNS server 712 in this order of priority.

More specifically, the network management software 30 first determines whether name resolution information including the provided DNS hostname is registered with the name resolution file 62. When name resolution information including the provided DNS hostname is registered with the name resolution file 62, the network management software 30 provides the IP address included in the name resolution information to the general software 41. When name resolution information including the provided DNS hostname is not registered with the name resolution file 62, the network management software 30 determines whether name resolution information including the provided DNS hostname is stored in the DNS cache 61.

When name resolution information including the provided DNS hostname is stored in the DNS cache 61, the network management software 30 provides the IP address included in the name resolution information to the general software 41. When name resolution information including the provided DNS hostname is not stored in the DNS cache 61, the network management software 30 accesses the DNS server 712 to acquire an IP address corresponding to the DNS hostname, and provides the acquired IP address to the general software 41. The network management software 30 also stores, into the DNS cache 61, name resolution information including the DNS hostname and the acquired IP address in a manner associated with each other.

In contrast, the management software 42 basically performs name resolution without using the network management software 30. More specifically, the management software 42 accesses the DNS server 712 to acquire an IP address corresponding to a DNS hostname. For example, the management software 42 provides the DNS hostname of the first communication device to the DNS server 712, and acquires the IP address of the first communication device from the DNS server 712. The management software 42 registers, with the routing table 60, the first record including the acquired IP address of the first communication device.

When the IP address of the first communication device acquired from the DNS server 712 varies, a mismatch may occur between the IP address of the first communication device included in the first record in the routing table 60 and the IP address of the first communication device acquired by the general software 41. For example, the management software 42 may acquire the IP address of the server 711A from the DNS server 712 to register the first record, whereas the general software 41 may acquire the IP address of the server 711B from the DNS server 712 or from the DNS cache 61 using the network management software 30 to access the first communication device.

In this case, the general software 41 attempts to access the server 711B using the IP address of the server 711B. However, the first record including the IP address of the server 711B is not registered with the routing table 60, and thus the general software 41 cannot access the server 711B.

Thus, in the present embodiment, the name resolution file 62 is updated to cause the IP address of the first communication device acquired by the general software 41 to match the IP address of the first communication device included in the first record registered with the routing table 60. In other words, the management software 42 updates the name resolution file 62 when registering the first record.

More specifically, the management software 42 accesses the DNS server 712 to acquire the IP address of the first communication device corresponding to the DNS hostname of the first communication device. The management software 42 registers, with the routing table 60, the first record including the acquired IP address of the first communication device. The management software 42 also registers name resolution information with the name resolution file 62. The name resolution information includes, in a manner associated with each other, the acquired IP address of the first communication device and the hostname of the first communication device.

In this case, the network management software 30 refers to the name resolution file 62 when receiving the hostname of the first communication device from the general software 41. The name resolution information registered with the name resolution file 62 includes, in a manner associated with each other, the hostname of the first communication device and the IP address of the first communication device. Thus, the network management software 30 acquires the IP address of the first communication device associated with the hostname of the first communication device in the name resolution information, and provides the acquired IP address to the general software 41. This ensures that the IP address of the first communication device provided to the general software 41 is included in the first record registered with the routing table 60. Thus, the general software 41 can access the first communication device using the acquired IP address of the first communication device.

The IP address of the first communication device acquired from the DNS server 712 can be disabled. For example, when the server 711A is excluded from the server 711, the IP address of the server 711A previously acquired from the DNS server 712 is disabled. Thus, the routing table 60 and the name resolution file 62 may be updated regularly. For example, the management software 42 may regularly perform the process of accessing the DNS server 712 to acquire the IP address of the first communication device, the process of updating the routing table 60 to include the acquired IP address in the first record, and the process of updating the name resolution file 62 to include the acquired IP address in the name resolution information.

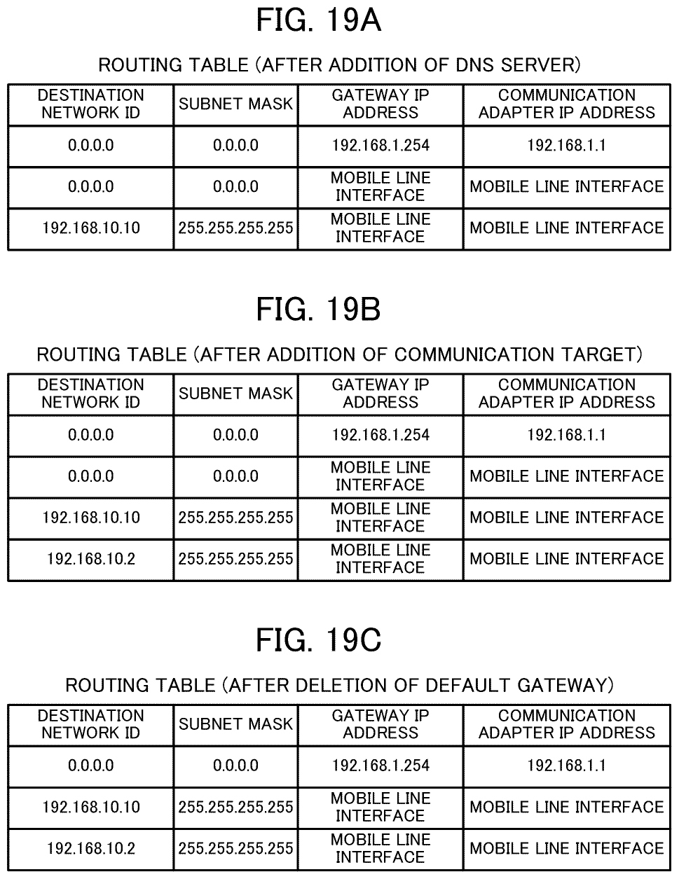

The details of the routing table 60 updated by the table manager 103 are now described with reference to FIGS. 19A to 19C. FIG. 19A is the routing table 60 after addition of a DNS server. As illustrated in FIG. 19A, the routing table 60 after addition of a DNS server includes the third record indicating the router 210 that is the second gateway as a default gateway, the second record indicating the communication adapter 171 that is the first communication adapter as a default gateway, and the fourth record for communicating with the DNS server 712 that is the first DNS server. In FIGS. 19A to 19C, the mobile line interface corresponds to the communication adapter 171. In FIG. 19A, the record in the first row is the third record, the record in the second row is the second record, and the record in the third row is the fourth record.

FIG. 19B is the routing table 60 after addition of a communication target. As illustrated in FIG. 19B, the routing table 60 after addition of a communication target is a table to which the first record for communicating with the server 711B as the first communication device has been added after addition of a DNS server.

FIG. 19C is the routing table 60 after deletion of a default gateway. As illustrated in FIG. 19C, the routing table 60 after deletion of a default gateway is a table from which the second record has been deleted after addition of a communication target. The second record indicates the communication adapter 171 that is the first communication adapter as a default gateway.

The communication device 150 can communicate with the DNS server 712 as the first DNS server by referring to the fourth record. The communication device 150 can also communicate with the server 711B as the first communication device by referring to the first record.

In the present embodiment, the path through a LAN selectively from the LANs and the mobile phone network is set as a default route. Thus, in the present embodiment, when the communication device has difficulty in acquiring the IP address of a communication target device connected through the LAN, for example, the communication device can communicate with both the communication target device connected through the LAN and a communication target device connected through the mobile phone network.

In the present embodiment, the fourth record that allows access to the first DNS server is registered with the routing table 60. Thus, in the present embodiment, the IP address of the first communication device can be identified using the DNS hostname of the first communication device by accessing the first DNS server.

In the present embodiment, the name resolution file 62 is referred to by the application software to perform name resolution. The name resolution information registered with the name resolution file 62 includes, in a manner associated with each other, the DNS hostname of the first communication device and the IP address of the first communication device. Thus, in the present embodiment, the application software can access the first communication device.

### Embodiment 6

In Embodiment 5, a method for allowing access to the first communication device using the name resolution file 62 is described. In the present embodiment, a method for allowing access to the first communication device without using the name resolution file 62 is described. The same components and functions as in Embodiments 1 to 5 are not described or are described briefly as appropriate.

In the present embodiment, when the first DNS server receives the DNS hostname of the first communication device, the first DNS server may transmit multiple IP addresses each as the IP address of the first communication device. More specifically, when the DNS server 712 receives the DNS hostname of the server 711, the DNS server 712 transmits the IP address of the server 711A, the IP address of the server 711B, and the IP address of the server 711C.

The second address identifier 106 identifies the multiple IP addresses received from the first DNS server each as the IP address of the first communication device. More specifically, the second address identifier 106 identifies all of the IP address of the server 711A, the IP address of the server 711B, and the IP address of the server 711C each as the IP address of the server 711.

The table manager 103 registers, with the routing table 60, the first records corresponding to the respective IP addresses identified by the second address identifier 106. More specifically, the table manager 103 registers, with the routing table 60, the first record including the IP address of the server 711A, the first record including the IP address of the server 711B, and the first record including the IP address of the server 711C.

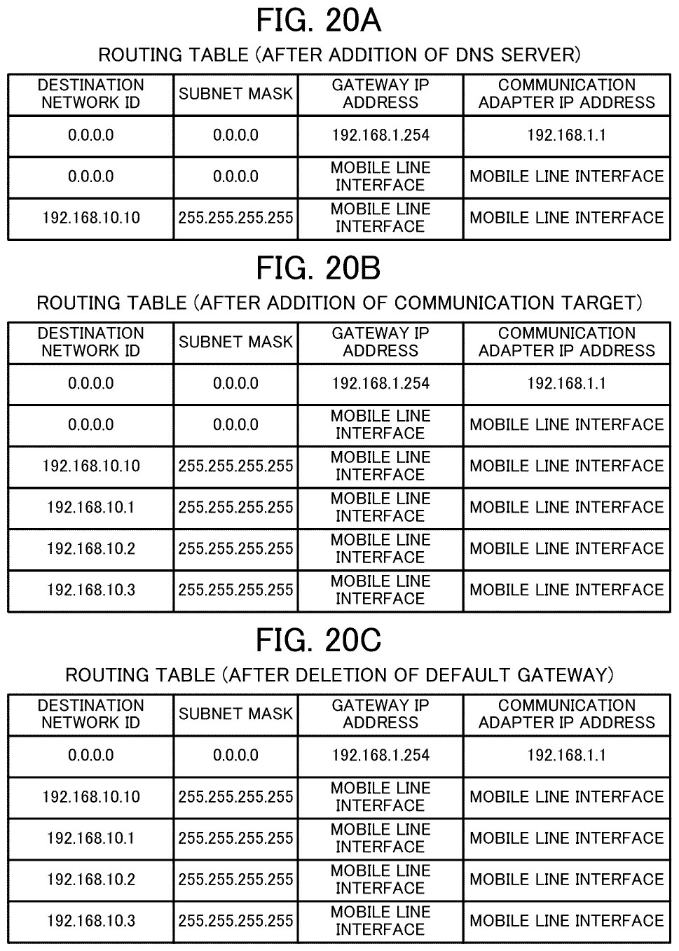

The details of the routing table 60 updated by the table manager 103 are now described with reference to FIGS. 20A to 20C. FIG. 20A is the routing table 60 after addition of a DNS server. The routing table 60 after addition of a DNS server illustrated in FIG. 20A is the same as the routing table 60 after addition of a DNS server illustrated in FIG. 19A.

FIG. 20B is the routing table 60 after addition of a communication target. As illustrated in FIG. 20B, the routing table 60 after addition of a communication target is a table to which the first records have been added after addition of a DNS server. The first records are the first record for communicating with the server 711A as the first communication device, the first record for communicating with the server 711B as the first communication device, and the first record for communicating with the server 711C as the first communication device.

FIG. 20C is the routing table 60 after deletion of a default gateway. As illustrated in FIG. 20C, the routing table 60 after deletion of a default gateway is a table from which the second record has been deleted after addition of a communication target. The second record indicates the communication adapter 171 that is the first communication adapter as a default gateway.

In the present embodiment, the first records are registered with the routing table 60 for all the respective IP addresses corresponding to the IP addresses of the servers 711. Thus, the general software 41 can access the server 711 using the IP address of the server 711 acquired from the network management software 30, independently of the acquired IP address of the server 711 being the IP address of the server 711A, the IP address of the server 711B, or the IP address of the server 711C.

The routing table 60 may be updated regularly when the IP address of the first communication device acquired from the DNS server 712 is potentially disabled. For example, the management software 42 may regularly perform the process of accessing the DNS server 712 to acquire multiple IP addresses of the first communication device and the process of updating the routing table 60 to include multiple first records corresponding to the respective IP addresses.

In the present embodiment, the first records are registered with the routing table 60 for the respective IP addresses acquired from the DNS server 712. Thus, in the present embodiment, the application software can access the first communication device without updating the name resolution file 62.

### Embodiment 7

In Embodiment 5 described above, the first communication device is each of the redundant servers 711 in the CDN 710. In the present embodiment described below, the first communication device is each of redundant NTP servers 721 in a network time protocol (NTP) system 720. The same components and functions as in Embodiments 1 to 6 are not described or are described briefly as appropriate.

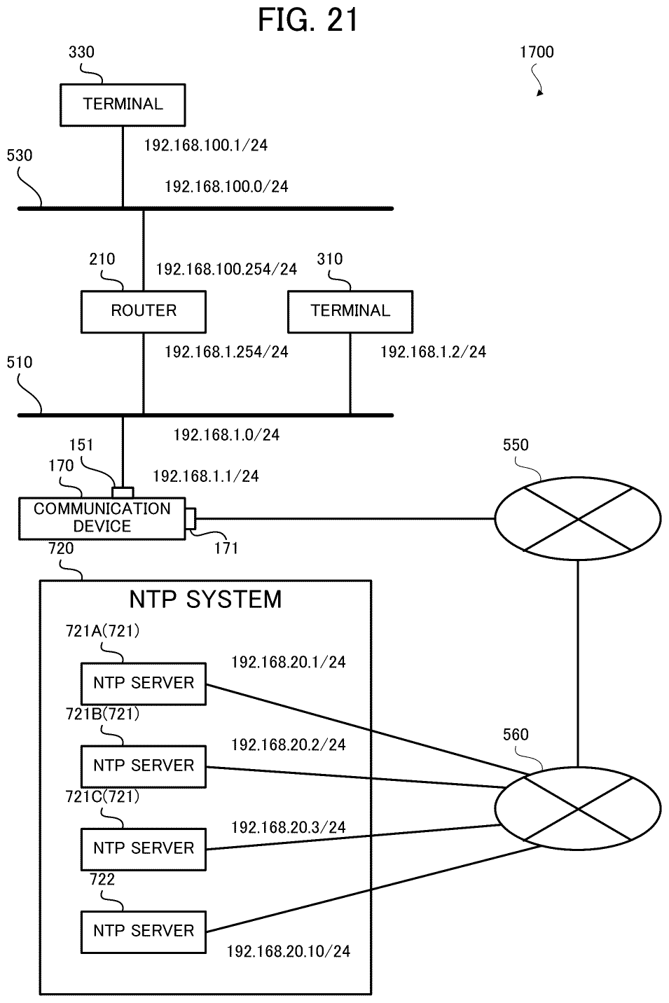

FIG. 21 is a block diagram of a network system 1700 according to the present embodiment. The network system 1700 includes a communication device 170, the router 210, the terminal 310, the terminal 330, an NTP server 721A, an NTP server 721B, an NTP server 721C, a DNS server 722, the communication network 510, the communication network 530, the communication network 550, and the communication network 560.

The NTP server 721A, the NTP server 721B, and the NTP server 721C are a group of servers that provide the same time information in the NTP system 720. The NTP system 720 synchronizes the time information of the devices connected to the network. More specifically, the NTP system 720 includes multiple redundant servers to provide the same time information. In the present embodiment, the NTP system 720 includes the NTP server 721A, the NTP server 721B, and the NTP server 721C. The NTP system 720 may include four or more NTP servers 721. The NTP server 721A, the NTP server 721B, and the NTP server 721C are collectively referred to as NTP servers 721.

The NTP server 721A, the NTP server 721B, and the NTP server 721C have the same DSN hostname. The communication device 170 as an NTP client acquires time information from one of the NTP server 721A, the NTP server 721B, or the NTP server 721C. Each NTP server 721 includes a communication adapter (not illustrated) for connecting to the communication network 560.

The DNS server 722 allows conversion of a DNS hostname and an IP address. The DNS server 722 performs name resolution for the servers in the NTP system 720. More specifically, the DNS server 722 performs name resolution for the NTP server 721A, the NTP server 721B, and the NTP server 721C.

For example, when the DNS server 722 receives the DNS hostname of the NTP server 721, the DNS server 722 transmits the IP addresses of all the NTP servers 721, or specifically the IP address of the NTP server 721A, the IP address of the NTP server 721B, and the IP address of the NTP server 721C. The communication device 170 as an NTP client selects one of all the received IP addresses and acquires time information from the NTP server 721 having the selected IP address. The DNS server 722 includes a communication adapter (not illustrated) for connecting to the communication network 560.

The NTP client can be set to either a server or a pool. When the NTP client is set to the server, the NTP client acquires the IP address of the NTP server 721 by performing name resolution using the network management software 30, and accesses the NTP server 721 using the acquired IP address. Thus, when the NTP client is set to the server, the NTP client refers to the name resolution file 62 to access the NTP server 721.

In contrast, when the NTP client is set to the pool, the NTP client acquires all the IP addresses of the NTP servers 721 at startup and stores the IP addresses into the storage 12. The NTP client selects an IP address from all the stored IP addresses under a predetermined procedure and accesses the NTP server 721 using the selected IP address. Thus, when the NTP client is set to the pool, the NTP client does not refer to the name resolution file 62 to access the NTP server 721.

In the present embodiment, a method for allowing access to the NTP server 721 using the name resolution file 62 when the NTP client is set to the server is described.

First, when the first DNS server receives the DNS hostname of the first communication device, the first DNS server transmits multiple IP addresses each as the IP address of the first communication device. More specifically, when the DNS server 722 receives the hostname of the NTP server 721 from the communication device 170, the DNS server 722 transmits the IP address of the NTP server 721A, the IP address of the NTP server 721B, and the IP address of the NTP server 721C, each as the IP address of the NTP server 721, to the communication device 170. The NTP server 721 is an example of the first communication device. The DNS server 722 is an example of the first DNS server.

The second address identifier 106 identifies, as the IP address of the first communication device, one of the multiple IP addresses received from the first DNS server. For example, the second address identifier 106 identifies, as the IP address of the NTP server 721, one of the IP address of the NTP server 721A, the IP address of the NTP server 721B, or the IP address of the NTP server 721C.

The table manager 103 registers, with the routing table 60, the first record including the IP address of the first communication device identified by the second address identifier 106. The table manager 103 also registers name resolution information with the name resolution file 62. The name resolution information includes, in a manner associated with each other, the DNS hostname of the first communication device and the IP address of the first communication device identified by the second address identifier 106.

In this manner, the management software 42 functions as, for example, the table manager 103 and the second address identifier 106, and synchronizes the information registered with the routing table 60 and the information registered with the name resolution file 62. For example, the management software 42 accesses the DNS server 722 to acquire multiple IP addresses of the first communication device corresponding to the DNS hostname of the first communication device. The management software 42 registers, with the routing table 60, the first record including an IP address selected from the acquired multiple IP addresses of the first communication device. The management software 42 also registers name resolution information with the name resolution file 62. The name resolution information includes, in a manner associated with each other, the selected IP address of the first communication device and the hostname of the first communication device.

In this case, the network management software 30 refers to the name resolution file 62 when receiving the hostname of the first communication device from the general software 41 with the NTP client. The name resolution information registered with the name resolution file 62 includes, in a manner associated with each other, the hostname of the first communication device and the IP address of the first communication device. Thus, the network management software 30 acquires the IP address of the first communication device associated with the hostname of the first communication device in the name resolution information, and provides the acquired IP address to the general software 41. This ensures that the IP address of the first communication device provided to the general software 41 is included in the first record registered with the routing table 60. Thus, the general software 41 can access the first communication device using the acquired IP address of the first communication device.

For load distribution, the use of a specific server alone of the NTP servers 721 is to be avoided. Thus, the routing table 60 and the name resolution file 62 may be regularly updated to regularly switch the NTP server 721 to be used. For example, the management software 42 stores multiple IP addresses acquired from the DNS server 722 into the storage 12, and regularly switches the IP address to be used. More specifically, the management software 42 may regularly perform the process of updating the routing table 60 to switch the IP address included in the first record and the process of updating the name resolution file 62 to switch the IP address included in the name resolution information.

The IP address of the first communication device acquired from the DNS server 722 may be disabled. For example, when the NTP server 721A is excluded from the NTP server 721, the IP address of the NTP server 721A previously acquired from the DNS server 722 is disabled. Thus, the management software 42 may regularly access the DNS server 722 to acquire multiple IP addresses of the first communication device.

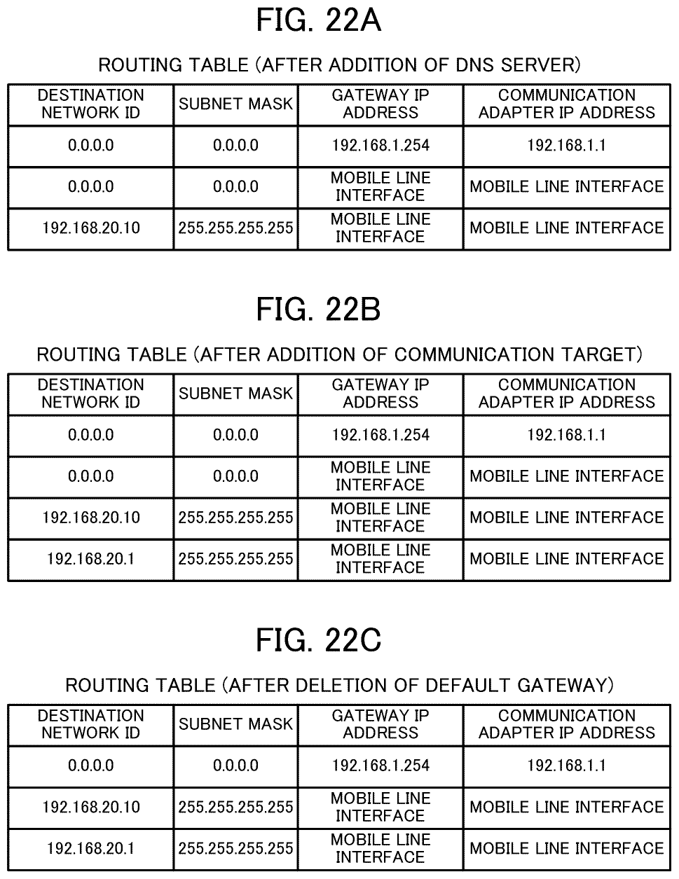

The details of the routing table 60 updated by the table manager 103 are now described with reference to FIGS. 22A to 22C. FIG. 22A is the routing table 60 after addition of a DNS server. The routing table 60 after addition of a DNS server illustrated in FIG. 22A is the same as the routing table 60 after addition of a DNS server illustrated in FIG. 19A.

FIG. 22B is the routing table 60 after addition of a communication target. As illustrated in FIG. 22B, the routing table 60 after addition of a communication target is a table to which the first record for communicating with the NTP server 721A as the first communication device has been added after addition of a DNS server.

FIG. 22C is the routing table 60 after deletion of a default gateway. As illustrated in FIG. 22C, the routing table 60 after deletion of a default gateway is a table from which the second record has been deleted after addition of a communication target. The second record indicates the communication adapter 171 that is the first communication adapter as a default gateway. The communication device 170 can communicate with the DNS server 722 as the first DNS server by referring to the fourth record. The communication device 170 can also communicate with the NTP server 721A as the first communication device by referring to the first record.

In the present embodiment, one of the multiple IP addresses acquired from the DNS server 722 is identified as the IP address of the first communication device. The first record including the identified IP address is registered with the routing table 60, and name resolution information including the identified IP address is registered with the name resolution file 62. Thus, in the present embodiment, the application software can access the first communication device.

### Embodiment 8

In Embodiment 7, a method for allowing access to the first communication device using the name resolution file 62 is described. In the present embodiment, a method for allowing access to the first communication device without using the name resolution file 62 is described. The same components and functions as in Embodiments 1 to 7 are not described or are described briefly as appropriate.

In the present embodiment, a method for allowing access to the NTP server 721 without using the name resolution file 62 when the NTP client is set to the pool is described.

First, when the first DNS server receives the DNS hostname of the first communication device, the first DNS server transmits multiple IP addresses each as the IP address of the first communication device. The second address identifier 106 identifies the multiple IP addresses received from the first DNS server each as the IP address of the first communication device. The table manager 103 registers, with the routing table 60, the first records including the respective IP addresses identified by the second address identifier 106.

In this manner, the management software 42 functions as, for example, the table manager 103 and the second address identifier 106, and accesses the first DNS server to acquire multiple IP addresses of the first communication device corresponding to the DNS hostname of the first communication device. The management software 42 registers, with the routing table 60, the multiple first records including the respective acquired IP addresses.

In this case, the general software 41 with the NTP client selects one of the multiple IP addresses of the first communication device stored in the general software 41 under a predetermined procedure, and attempts to access the first communication device using the selected IP address. This ensures that multiple IP addresses of the first communication device stored in the general software 41 are all included in the first record registered with the routing table 60. Thus, the general software 41 can access the first communication device using the selected IP address of the first communication device.

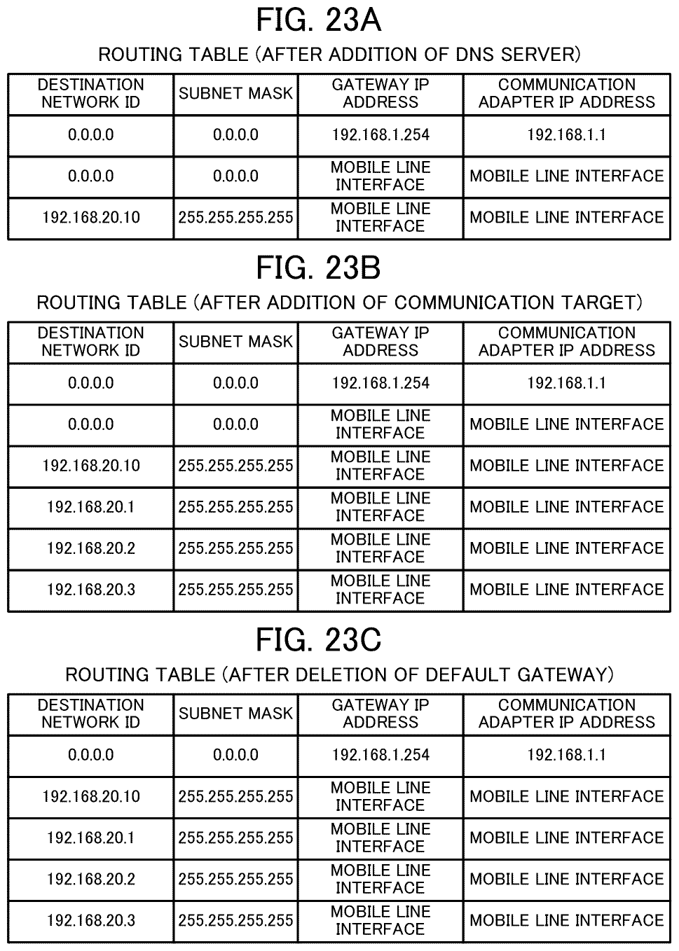

The details of the routing table 60 updated by the table manager 103 are now described with reference to FIGS. 23A to 23C. FIG. 23A is the routing table 60 after addition of a DNS server. The routing table 60 after addition of a DNS server illustrated in FIG. 23A is the same as the routing table 60 after addition of a DNS server illustrated in FIG. 22A.

FIG. 23B is the routing table 60 after addition of a communication target. As illustrated in FIG. 23B, the routing table 60 after addition of a communication target is a table to which the first records have been added after addition of a DNS server. The first records are the first record for communicating with the NTP server 721A as the first communication device, the first record for communicating with the NTP server 721B as the first communication device, and the first record for communicating with the NTP server 721C as the first communication device.

FIG. 23C is the routing table 60 after deletion of a default gateway. As illustrated in FIG. 23C, the routing table 60 after deletion of a default gateway is a table from which the second record has been deleted after addition of a communication target. The second record indicates the communication adapter 171 that is the first communication adapter as a default gateway.

The communication device 170 can communicate with the DNS server 722 as the first DNS server by referring to the fourth record. The communication device 170 can also communicate with the three NTP servers 721, each as the first communication device, by referring to the three first records.

In the present embodiment, the first records are registered with the routing table 60 for the respective IP addresses acquired from the DNS server 722. Thus, in the present embodiment, the application software can access the first communication device without updating the name resolution file 62.

### Modifications

The embodiments of the present disclosure described above may be modified or applied in various forms to implement the present disclosure. In the present disclosure, the components, functions, and operations described in the above embodiments may be selectively used as appropriate. In the present disclosure, further components, functions, and operations may also be used other than the components, functions, and operations described above. The components, functions, and operations described in the above embodiments may be combined as appropriate.

The number and types of communication networks to which the communication device is connected are not limited to the number and types described in Embodiments 1 to 3. For example, the communication device may be connected to four or more communication networks. The communication device may be connected to one LAN and one mobile phone network. The communication device may be connected to three LANs. As typical modifications, Modification 1 and Modification 2 are described below.

### Modification 1

A network system according to Modification 1 includes a first communication network as a LAN and a second communication network as a mobile phone network. The first communication network is, for example, the communication network 510 in Embodiment 3. The second communication network is, for example, the communication network 550 in Embodiment 3. More specifically, the network system according to Modification 1 basically corresponds to the network system according to Embodiment 3 from which the communication network 520 is eliminated. In Modification 1, the second path through the second communication network is set as a default route.

In Modification 1, the first record includes the IP address of the first communication device as the destination network ID, a full-bit subnet mask as the subnet mask, and the IP address of the first gateway as the gateway IP address. The first communication device is, for example, the terminal 330 in Embodiment 3. The first gateway is, for example, the router 210 in Embodiment 3. The second record indicates the first gateway as a default gateway. The third record indicates the second communication adapter as a default gateway. The second communication adapter is, for example, the communication adapter 171 in Embodiment 3.

In Modification 1, the communication device can communicate with the first communication device through the first communication network as indicated by the first record registered with the routing table. In Modification 1, the communication device can also communicate with the second communication device connected to the communication device through the second communication network based on the default route indicated by the routing table. The second communication device is, for example, the terminal 370 in Embodiment 3.

### Modification 2

A network system according to Modification 2 includes a first communication network as a mobile phone network and a second communication network as a LAN. The first communication network is, for example, the communication network 550 in Embodiment 3. The second communication network is, for example, the communication network 510 in Embodiment 3. More specifically, the network system according to Modification 2 basically corresponds to the network system according to Embodiment 3 from which the communication network 520 is eliminated. In Modification 2, the second path through the second communication network is set as a default route.

In Modification 2, the first record includes the IP address of the first communication device as the destination network ID, a full-bit subnet mask as the subnet mask, and the identification information of the first communication adapter as the gateway IP address. The first communication device is, for example, the terminal 370 in Embodiment 3. The first communication adapter is, for example, the communication adapter 171 in Embodiment 3. The second record indicates the first communication adapter as a default gateway. The third record indicates the second gateway connected to the second communication network as a default gateway. The second gateway is, for example, the router 210 in Embodiment 3.

In Modification 2, the communication device can communicate with the first communication device through the first communication network as indicated by the first record registered with the routing table. In Modification 2, the communication device can also communicate with the second communication device connected to the communication device through the second communication network based on the default route indicated by the routing table. The second communication device is, for example, the terminal 330 in Embodiment 3.

### Other Modifications

With the method described in each of Embodiments 1 to 3, the records other than a single record indicating the single specified default gateway are deleted, selectively from multiple records indicating default gateways. Another method may be used to indicate a single default gateway with the routing table. For example, each record registered with the routing table may include a metric value. The metric value in the record indicating the specified default gateway may be set to a minimum value. In this case, records indicating default gateways and including metric values other than the minimum metric value are substantially not used.

The default route may be indicated by any record that can identify the communication adapter to be used when no record corresponding to a communication target is registered with the routing table. For example, in Embodiment 3, the second communication adapter and the second communication network may have identifiers associated with each other. In this case, the third record may be the identifier of the second communication network, rather than the identifier of the second communication adapter. In this structure as well, the identifier of the second communication network indicated by the third record can identify the communication adapter to be used when no record corresponding to a communication target is registered with the routing table.

In Embodiments 1 to 3 described above, the default gateway is specified using specification information. The default gateway may be determined automatically. For example, a gateway registered with the routing table and not indicated by the record corresponding to a communication target device may be set as a default gateway. For example, in Embodiment 3, the first record corresponding to the first communication device may indicate the first gateway, and the fifth record corresponding to the third communication device may indicate the third gateway. In this case, the second communication adapter may be set as a default gateway.

In Embodiment 3 described above, the communication adapter 171 is set as a default gateway. The router 210 or the router 220 may be set as a default gateway. A router or a communication adapter used for communication with a large number of unspecified communication target devices may be set as a default gateway. For example, a router or a communication adapter used for communication with a communication target device having an IP address that is difficult to identify may be set as a default gateway. In some embodiments, a router or a communication adapter used for communication with the largest number of communication target devices may be set as a default gateway.

In Embodiment 7 described above, when the NTP client is set to the server, the NTP client selects one of the acquired multiple IP addresses and updates the routing table 60 and the name resolution file 62 to communicate with the first communication device having the selected IP address. When the NTP client is set to the server, the NTP client may update the routing table 60 to communicate with all the first communication devices without using the name resolution file 62, as in Embodiment 8.

In Embodiments 7 and 8 described above, the NTP client is a resident NTP client. The NTP client may be an NTP client with single time invocation. In this case as well, the information in the routing table 60 may be synchronized with the information in the name resolution file 62 in the same manner as in Embodiment 7, or the routing table 60 may be updated to include first records corresponding to all the acquired IP addresses in the same manner as in Embodiment 8.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of International Application No. PCT/JP2023/001219 filed on Jan. 17, 2023 and International Application No. PCT/JP2023/021348 filed on Jun. 8, 2023, the entire disclosure of which is incorporated by reference herein.

### INDUSTRIAL APPLICABILITY

The technique according to one or more embodiments of the present disclosure may be used for a network system including multiple communication networks.

1. A communication device connectable to a first communication network and a second communication network, the communication device comprising:
a first communication adapter connectable to the first communication network;
a second communication adapter connectable to the second communication network;
a memory to store a routing table with which a record is registered, the record including a destination network ID, a subnet mask, and a gateway IP address, where ID is identification, and IP is Internet Protocol; and
processing circuitry to register a first record with the routing table and update the routing table to indicate a second path as a default route selectively from a first path through the first communication network and the second path through the second communication network, the first record including, as the destination network ID, an IP address of a first communication device connected to the communication device through the first communication network, including a full-bit subnet mask as the subnet mask, and including, as the gateway IP address, an IP address of a first gateway connected to the first communication network or identification information of the first communication adapter.

2. The communication device according to claim 1, wherein
the processing circuitry registers the first record with the routing table, and deletes a second record from the routing table selectively from the second record indicating the first path as the default route and a third record indicating the second path as the default route.

3. The communication device according to claim 2, wherein
each of the first communication network and the second communication network is a local area network,
the first record includes the IP address of the first gateway as the gateway IP address,
the second record indicates the first gateway as a default gateway, and
the third record indicates, as the default gateway, a second gateway connected to the second communication network.

4. The communication device according to claim 2, wherein
the first communication network is a local area network,
the second communication network is a mobile phone network,
the first record includes the IP address of the first gateway as the gateway IP address,
the second record indicates the first gateway as a default gateway, and
the third record indicates the second communication adapter as the default gateway.

5. The communication device according to claim 1, wherein
the processing circuitry acquires, from a user, communication target information identifying the IP address of the first communication device and the IP address of the first gateway, and
the processing circuitry registers the first record with the routing table, and the first record includes, as the destination network ID, the IP address of the first communication device identified using the communication target information, and includes, as the gateway IP address, the IP address of the first gateway identified using the communication target information.

6. The communication device according to claim 5, wherein
the communication target information includes the IP address of the first communication device and the identification information of the first communication adapter,
the processing circuitry identifies the IP address of the first gateway using the identification information of the first communication adapter included in the communication target information, and
the processing circuitry registers the first record with the routing table, and the first record includes, as the destination network ID, the IP address of the first communication device included in the communication target information, and includes, as the gateway IP address, the identified IP address of the first gateway.

7. The communication device according to claim 5, wherein
the processing circuitry registers a fourth record with the routing table, and the fourth record includes, as the destination network ID, an IP address of a first DNS server associating the IP address of the first communication device with a DNS hostname of the first communication device, includes the full-bit subnet mask as the subnet mask, and includes the IP address of the first gateway as the gateway IP address, where DNS is a domain name system,
the communication target information includes the DNS hostname of the first communication device and the identification information of the first communication adapter,
the processing circuitry accesses the first DNS server and identifies the IP address of the first communication device using the DNS hostname of the first communication device included in the communication target information, and
the processing circuitry registers the first record with the routing table, and the first record includes, as the destination network ID, the identified IP address of the first communication device, and includes, as the gateway IP address, the IP address of the first gateway identified using the identification information of the first communication adapter included in the communication target information.

8. The communication device according to claim 1, wherein
the communication device is connectable to the first communication network, the second communication network, and a third communication network,
the communication device further comprises a third communication adapter connectable to the third communication network, and
the processing circuitry registers a fifth record with the routing table and updates the routing table to indicate, as the default route, the second path selectively from the first path, the second path, and a third path through the third communication network, and the fifth record includes, as the destination network ID, an IP address of a third communication device connected to the communication device through the third communication network, includes the full-bit subnet mask as the subnet mask, and includes, as the gateway IP address, an IP address of a third gateway connected to the third communication network or identification information of the third communication adapter.

9. The communication device according to claim 8, wherein
the processing circuitry registers the first record and the fifth record with the routing table, and deletes a second record and a sixth record from the routing table selectively from the second record indicating the first path as the default route, a third record indicating the second path as the default route, and the sixth record indicating the third path as the default route.

10. The communication device according to claim 9, wherein
each of the first communication network and the third communication network is a local area network,
the second communication network is a mobile phone network,
the first record includes the IP address of the first gateway as the gateway IP address,
the second record indicates the first gateway as a default gateway,
the third record indicates the second communication adapter as the default gateway,
the fifth record includes the IP address of the third gateway as the gateway IP address, and
the sixth record indicates the third gateway as the default gateway.

11. The communication device according to claim 2, wherein
the first communication network is a mobile phone network,
the second communication network is a local area network,
the first record includes the identification information of the first communication adapter as the gateway IP address,
the second record indicates the first communication adapter as a default gateway, and
the third record indicates, as the default gateway, a second gateway connected to the second communication network.

12. The communication device according to claim 11, wherein
the processing circuitry registers a fourth record with the routing table, and the fourth record includes, as the destination network ID, an IP address of a first DNS server associating the IP address of the first communication device with a DNS hostname of the first communication device, includes the full-bit subnet mask as the subnet mask, and includes the identification information of the first communication adapter as the gateway IP address,
the processing circuitry accesses the first DNS server and identifies the IP address of the first communication device using the DNS hostname of the first communication device, and
the processing circuitry registers the first record with the routing table, and the first record includes, as the destination network ID, the identified IP address of the first communication device, and includes the identification information of the first communication adapter as the gateway IP address.

13. The communication device according to claim 12, wherein
the first DNS server transmits, as the IP address of the first communication device, an IP address of a plurality of IP addresses when receiving the DNS hostname of the first communication device,
the processing circuitry identifies the IP address received from the first DNS server as the IP address of the first communication device, and
the processing circuitry registers name resolution information with a name resolution file, the name resolution information includes, in a manner associated with each other, the DNS hostname of the first communication device and the identified IP address of the first communication device, and the name resolution file is referred to by application software to identify the IP address of the first communication device using the DNS hostname of the first communication device.

14. The communication device according to claim 12, wherein
the first DNS server transmits a plurality of IP addresses each as the IP address of the first communication device when receiving the DNS hostname of the first communication device,
the processing circuitry identifies, as the IP address of the first communication device, an IP address of the plurality of IP addresses received from the first DNS server, and
the processing circuitry registers name resolution information with a name resolution file, the name resolution information includes, in a manner associated with each other, the DNS hostname of the first communication device and the identified IP address of the first communication device, and the name resolution file is referred to by application software to identify the IP address of the first communication device using the DNS hostname of the first communication device.

15. The communication device according to claim 12, wherein
the first DNS server transmits a plurality of IP addresses each as the IP address of the first communication device when receiving the DNS hostname of the first communication device,
the processing circuitry identifies each of the plurality of IP addresses received from the first DNS server as the IP address of the first communication device, and
the processing circuitry registers the first record with the routing table, and the first record corresponds to each of the identified plurality of IP addresses.

16. The communication device according to claim 1, further comprising:
network management software to update the routing table to change a network setting of the communication device;
an operating system to detect a change in the network setting performed by the network management software and provide a notification of the change; and
setting correction software being application software to update the routing table to correct the network setting,
wherein when the setting correction software receives a notification of a change in the network setting from the operating system and the routing table indicates the first path and the second path each as the default route, the setting correction software registers the first record with the routing table and updates the routing table to indicate the second path as the default route.

17. The communication device according to claim 16, wherein
the setting correction software registers, with a recovery file stored in the memory, information indicating the first record and information indicating the second path as the default route, and
when the network management software deletes the first record from the routing table and updates the routing table to indicate the first path and the second path each as the default route, the setting correction software registers the first record with the routing table and updates the routing table to indicate the second path as the default route based on the recovery file.

18. A communication device connectable to a plurality of communication networks with a plurality of communication adapters, the communication device comprising:
network management software to change a network setting of the communication device;
an operating system to detect a change in the network setting performed by the network management software and provide a notification of the change; and
setting correction software being application software to correct the network setting,
wherein when the setting correction software receives a notification of a change in the network setting from the operating system and the network setting indicates a plurality of gateways each as a default gateway, the setting correction software corrects the network setting to indicate, as the default gateway, a gateway specified from the plurality of gateways.

19. The communication device according to claim 18, wherein
the setting correction software corrects the network setting to indicate the specified gateway as the default gateway to allow communication between the communication device and a first communication device connected to the communication device with a first gateway of the plurality of gateways other than the specified gateway.

20. The communication device according to claim 19, further comprising:
a memory to store a routing table with which a record is registered, the record including a destination network ID, a subnet mask, and a gateway IP address,
wherein the setting correction software registers a first record with the routing table and updates the routing table to indicate a specified path through the specified gateway as a default route, and the first record includes an IP address of the first communication device as the destination network ID, includes a full-bit subnet mask as the subnet mask, and includes, as the gateway IP address, an IP address of the first gateway or identification information of a first communication adapter of the plurality of communication adapters to connect the communication device to the first gateway.

21. The communication device according to claim 20, wherein
the setting correction software registers, with a recovery file stored in the memory, information indicating the first record and information indicating the specified path as the default route, and
when the network management software deletes the first record from the routing table and updates the routing table to indicate a plurality of paths each as the default route, the setting correction software registers the first record with the routing table and updates the routing table to indicate the specified path as the default route based on the recovery file.

22. A network system, comprising:
a first communication network;
a second communication network;
a communication device connectable to the first communication network and the second communication network; and
a first gateway connectable to the first communication network, the communication device including
a first communication adapter connectable to the first communication network,
a second communication adapter connectable to the second communication network,
a memory to store a routing table with which a record is registered, the record including a destination network ID, a subnet mask, and a gateway IP address, where ID is identification, and IP is Internet Protocol, and
processing circuitry to register a first record with the routing table and update the routing table to indicate a second path as a default route selectively from a first path through the first communication network and the second path through the second communication network, the first record including, as the destination network ID, an IP address of a first communication device connected to the communication device through the first communication network, including a full-bit subnet mask as the subnet mask, and including, as the gateway IP address, an IP address of the first gateway or identification information of the first communication adapter.

23. A communication method implementable with a communication device connectable to a first communication network and a second communication network, the method comprising:
connecting to the first communication network with a first communication adapter;
connecting to the second communication network with a second communication adapter;
storing a routing table with which a record is registered, the record including a destination network ID, a subnet mask, and a gateway IP address, where ID is identification, and IP is Internet Protocol;
registering a first record with the routing table, the first record including, as the destination network ID, an IP address of a first communication device connected to the communication device through the first communication network, including a full-bit subnet mask as the subnet mask, and including, as the gateway IP address, an IP address of a first gateway connected to the first communication network or identification information of the first communication adapter;
updating the routing table to indicate a second path as a default route selectively from a first path through the first communication network and the second path through the second communication network;
communicating with the first communication device through the first communication network based on the first record registered with the routing table; and
communicating with a second communication device through the second communication network based on the default route indicated by the routing table, the second communication device being connected to the communication device through the second communication network.

24. A non-transitory computer-readable recording medium storing a program executable by a computer included in a communication device, the communication device including a first communication adapter connectable to a first communication network, a second communication adapter connectable to a second communication network, and a memory to store a routing table with which a record is registered, the record including a destination network ID, a subnet mask, and a gateway IP address, the program causing the computer to function as:
a table management manager to register a first record with the routing table and update the routing table to indicate a second path as a default route selectively from a first path through the first communication network and the second path through the second communication network, the first record including, as the destination network ID, an IP address of a first communication device connected to the communication device through the first communication network, including a full-bit subnet mask as the subnet mask, and including, as the gateway IP address, an IP address of a first gateway connected to the first communication network or identification information of the first communication adapter.
